(19) United States
(12) Patent Application Publication
(10) Pub. No.: US 2017/0066932 A1
(43) Pub. Date: Mar. 9, 2017

(54) LIGHT ABSORBING FILMS

(71) Applicants: Yissum Research Development Company of the Hebrew University of Jerusalem Ltd, Jerusalem (IL); Nanyang Technological University, Singapore (SG)

(72) Inventors: Shlomo MAGDASSI, Jerusalem (IL); Camille ZWICKER, Jerusalem (IL); Subodh Gautam MHAISALKAR, Singapore (SG); Daniel MANDLER, Jerusalem (IL); Lihi LEVI, Rishon LeZion (IL); Suzanna AZOUBEL, Jerusalem (IL)

(73) Assignees: Yissum Research Development Company of the Hebrew University of Jerusalem Ltd, Jerusalem (IL); Nanyang Technological University, Singapore (SG)

(21) Appl. No.: 15/122,846

(22) PCT Filed: Mar. 10, 2015
(86) PCT No.: PCT/IL2015/050251

§ 371 Date: Aug. 31, 2016

Related U.S. Application Data
(60) Provisional application No. 61/950,279, filed on Mar. 10, 2014.

(51) Int. Cl. C09D 5/32; C03C 17/32; G02B 1/10; C09D 7/12; G02B 5/00

(52) U.S. Cl. CPC C09D 5/32; C09D 7/1216; G02B 5/003; G02B 1/10; C03C 17/32; Y10S 977/742; B82Y 20/00

(57) ABSTRACT

Provided is a spectrally selective solar thermal coating, formed as a continuous uniform layer, combining a light-absorbing coating and an infrared (IR) reflecting layer positioned on top of the absorber coating. The coating is adapted for use in a plurality of applications, including amongst many control of stray light and absorptivity in thermosolar devices.

### TECHNOLOGICAL FIELD

The present disclosure generally relates to absorbing formulations and uses thereof for coating structures.

### BACKGROUND OF THE INVENTION

The performance of optical devices, regardless of their complexity, is affected by stray light. The effect of stray light in optical systems may vary from low performance (reduced contrast on the image plane, obscure faint signals or false ones, false artifacts across the image plane, and magnitude errors in radiometric measurements) to physical damage (damaging fragile optical components and burning out detectors) [1].

Stray light can be reduced to a tolerable level by proper design of the mechanical system or by using functional black optical coatings in elements of the optical system.

A functional optical absorbing coating can be made of an ideal black material which is capable of absorbing light, at all angles and over all wavelengths. Common methods for producing such coatings are metal anodizing with an inorganic black coloring process [2-5] and electroless deposition of nickel oxide coating [6-9]. Both methods require several process steps, including substrate surface pre-treatment.

Carbon nanotubes (CNTs) have unique electrical and mechanical properties, excellent light absorbing properties, and are therefore, ideal candidates for super black coating, especially when grown as vertically aligned forests.

A CNT forest (aligned dense nanotubes placed perpendicularly to the surface) has been used as optical coating [10]. Although this type of coating shows good light absorption and some anti-reflective performance, its production requires unique equipment and specific conditions, since the CNT forest, which is usually grown by chemical vapor deposition (CVD) under high temperature and pressure. This process has several drawbacks, such as the coating substrate type and area, and poor adhesion to the substrate.

Strongly absorbing materials are also needed for forming functional, high-absorbing coatings for solar energy conversion. Solar thermal energy/power is one of the leading approaches for solar energy conversion, which is mainly used in concentrated solar power (CSP) systems. The common basis for all CSP technologies is the solar absorber [11] which collects the solar spectrum and converts it into heat. This absorber may be subjected to extreme temperatures, depending on its final application. The key component in solar absorber is the spectrally solar selective absorbing coating.

Candidates for such solar absorber layers, such as black Ni, black Cu, PbS, black chrome, spinels and metal oxides black paints [12], can be applied onto a variety of structural absorber plate materials, such as carbon steel, galvanized steel, stainless steel, copper and aluminum [12]. However, most of the coating technologies involve vacuum (physical and chemical) deposition [13] and sputtering [14].

Multi-walled carbon nanotubes (MWCNT) are exceptionally good absorbers, with a potential of reaching 99% absorption in the UV-visible range [15]. CNT-containing films have a large surface area and high thermal conductivity [16], which enables rapid heat transfer from CNT to the underlying metal. However, the studies [17-23] whereby CNT were used as solar absorber for solar thermal conversion did not achieve suitable results.

In patent application US 2009/0314284 [35], solar coating was prepared by electrophoretic deposition of CNT together with alumina nanoparticles and PVP The highest absorptance of the resulting coatings was only 0.7, which is far below that required for thermal solar applications. In reality, an efficient solar selective absorber should have an absorptance of >0.9 and an emittance of <0.2. Most of these CNT based coatings showed poor spectral selectivity of absorption. Therefore, it is highly desired to develop spectrally solar selective coating which has high absorptance, low emittance, good adhesion to the underlying metal substrate and high thermal stability for prolonged time.

Beigbeder et al. [25] describe a cold control thermal coating comprising polysiloxane (PDMS) resin filled with different conducting nanoparticles: indium tin oxide (ITO), zinc oxide (ZnO) and multi-walled CNT with antistatic properties and a high electrical conductivity. The CNT/PDMS composites exhibited electrical charges dissipation under sirene irradiation but thermo-optical properties were too degraded. The thermal emissivity obtained was around 0.8.

### REFERENCES

[1] Frank Trager, Springer Handbook of Lasers and Optics, Springer, New York, 2007.
[2] Y. Goueffon, L. Arurault, C. Mabru, C. Tonon, P. Guigue, J. Mater. Process. Technol. 209 (2009) 5145-5151.
[3] A. K. Sharma, H. Bhojraj, V. K. Kaila, H. Narayanamurthy, Met. Finish. 95 (1997) 14-20.
[4] A. K. Sharma, R. U. Rani, H. Bhojaraj, H. Narayanamurthy, J. Appl. Electrochem. 23 (1993) 500-507.
[5] R. J. Fenolia, M. E. Marousek, D. C. Nagle, D. F. Shepard, High-temperature, high-emissivity, optically black boron surface, U.S. Pat. No. 5,035,949 (1991).
[6] V. Saxena, R. U. Rani, A. K. Sharma, Surf. Coat. Technol. 201 (2006) 855-862.
[7] S. N. Kumar, L. K. Malhotra, K. L. Chopra, Sol. Energy Mater. 3 (1980) 519-532.
[8] R. J. C. Brown, P. J. Brewer, M. J. T. Milton, J. Mater. Chem. 12 (2002) 2749-2754.
[9] R. U. Rani, A. K. Sharma, C. Minu, G. Poornima, S. Tejaswi, J. Appl. Electrochem. 40 (2010) 333-339.
[10] K. Mizuno, J. Ishii, H. Kishida, Y. Hayamizu, S. Yasuda, D. N. Futaba, M. Yumura, K. Hata, PNAS 106 (2009) 6044-6047.
[11] IEA, Technology Roadmap—Concentrating Solar Power, in, 2010.
[12] C. E. Kennedy, NREL/TP-520-31267, July 2002.
[13] N. Selvakumar, H. C. Barshilia, Sol. Energy Mater. Sol. Cells 2012, 98 1-23.
[14] Q.-C. Zhang, Sol. Energy Mater. Sol. Cells 2000, 62, 63-74.
[15] J. G. Hagopian, S. A. Getty, M. Quijada, J. Tveekrem, R. Shiri, P. Roman, J. Butler, G. Georgiev, J. Livas, C. Hunt, A. Maldonado, Proc. of SPIE 2010, 7761, 77610F.
[16] D. J. Yang, Q. Zhang, G. Chen, S. F. Yoon, J. Ahn, S. G. Wang, Q. Zhou, Q. Wang, and J. Q. Li, Phys. Rev. B 2002, 66, 165440.
[17] A. Cao, X. Zhang, C. Xu, B. Wei, D. Wu, Sol. Energy Mater. Sol. Cells 2002, 70, 481-486.
[18] M. E. Rincon, J. D. Molina, M. Sanchez, C. Arancibia, E. Garcia, Sol. Energy Mater. Sol. Cells 2007, 91, 1421-1425.
[19] K. Roro, N. Tile, B. Mwakikunga, B. Yalisi, A. Forbes, Mater. Sci. Eng. B 2012, 177, 581-587.
[20] M. Kurzbock, G. M. Wallner, R. W. Lang, Energy Procedia 2012, 30, 438-445.
[21] A. B. Kaul, J. B. Coles, M. Eastwood, R. O. Green, P. R. Bandaru, Small 2013, 9, 1058-1065.
[22] N. Selvakumar, S. B. Krupanidhi, H. C. Barshilia, Adv. Mater. 2014, 26, 2552-2557.
[23] N. T. Panagiotopoulos, E. K. Diamanti, L. E. Koutsokeras, M. Baikousi, E. Kordatos, T. E. Matikas, D. Gournis, P. Patsalas, ACS Nano 2012, 6, 10475-10485.
[24] US 2009/0314284.
[25] J. Beigbeder, P. Demont, S. Remaury, P. Nabarra and C. Lacabanne, “Incorporation of nanoparticles in a flexible solar reflector for geostationary applications” (2009) in: http://esmat.esa.int/materials_news/isme09/pdf/PROGRAMME_ISMSE-2009.pdf.

### SUMMARY OF THE INVENTION

The objective of the present invention is to provide a non-reflective, high light-absorbing coating. This coating is performed by conventional air spraying process, is suitable for rapid coverage of large areas of various substrates. The resulting coatings are suitable for stray light absorption in optical devices, can be easily performed for complex 3D structures, and due to their excellent adhesion are suitable for use in space or terrestrial applications.

The invention disclosed herein provides a light-absorbing black coating with light absorbance of at least 90%. To ensure a good adhesion of the black coating to a substrate, the absorbing material was combined with a heat resistant binder, at various weight ratios, to provide, after heating, a ceramic coating about 2-20 μm thick.

The invention further provides a spectrally selective solar thermal coating, formed as a continuous and uniform layer which combines the light-absorbing coating and an infrared (IR) reflecting layer positioned on top of the absorber coating. The coating of the invention exhibits excellent spectral selectivity with high absorptance of 0.927 and low emittance of 0.2. The deposition of the reflecting layer, e.g. ITO on an absorber coating, e.g., made of CNT, decreased the emissivity by at least 20% as compared to a coating without a reflecting layer.

The coatings of the invention may be used in a plurality of applications, including amongst many as means to control stray light and as means to improve absorptivity in thermosolar devices.

As known in the art, “stray light” is unwanted light in an optical system, which may be a minor annoyance, in some applications, but in others, such as in space-based technologies, such as a space-based telescope, it may result in the loss of important data. The negative effect stray light may have on a variety of optical systems makes it necessary to design optical systems which are capable of minimizing or at least capable of controlling it.

Thus, the invention generally provides means to control stray light, e.g., in an optical device, the means being in a form of a substrate coated with at least one light-absorbing material, having a light absorbance of at least 90% (absorptivity above 0.90).

In a first aspect, there is provided an element coated on at least a region of its surface with (a film or layer or coat of) at least one light-absorbing material, the light-absorbing material being associated with said at least a region via a binder material, such that the light absorbance of the film, layer or coat is at least 90%. The element of the invention is suited for stray-light suppression.

As used herein, the term “light suppression” refers to the ability of an element of the invention to absorb stray light, in some embodiments, at least 90% (or 91%, 92%, 93%, 94%, 95%, 96%, 97%, 98% or 99% of the light) of stray light directed at or in the vicinity of the element. As the element of the invention has an extremely high light-absorbing characteristic, it may be regarded as suppressing light or as black.

The element may additionally be used to serve to remove heat from instruments and devices in which it is utilized and radiate it away. This ability of an element of the invention cools the instrument or device to lower temperatures, in combination with its high light-absorbing capabilities, render the instrument or device more sensitive to, e.g., faint signals.

In some embodiments, the element of the invention comprises a substrate coated on at least a region thereof with a coat or film comprising at least one binder material which comprises or contains or embeds the at least one light-absorbing material, and optionally at least one additive, the light-absorbance of the coat or film being at least 90%.

In some embodiments, the light absorbance is of 90%, 91%, 92%, 93%, 94%, 95%, 96%, 97%, 98% or 99%. In other embodiments, light absorbance is of between 90% and 99%, between 90% and 98%, between 90% and 97%, between 90% and 96%, between 90% and 95%, between 90% and 94%, between 90% and 93%, between 90% and 92% or between 90% and 91%.

The amount of the binder material and the at least one light-absorbing material is adapted to permit, at one hand, maximal light absorption, and at the other hand, effective binding of the light-absorbing material to a surface region of the substrate. In some embodiments, the film comprises at least 1% of the light-absorbing material. In other embodiments, the film comprises at most 10% of the light-absorbing material. In further embodiments, the film comprises between 1% and 10% of the light-absorbing material.

In further embodiments, the film comprises 1, 2, 3, 4, 5, 6, 7, 8, 9, or 10% (w/w) of the light absorbing material.

In some embodiments, the film comprises between 1 and 5%, between 2 and 6%, between 3 and 7%, between 4 and 8%, between 5 and 9% or between 6 and 10% of the light absorbing material.

Thus, in some embodiments, the invention provides an element comprising a substrate coated on at least a region thereof with a coat or film of at least one binder material which comprises or contains or embeds at least one light-absorbing material in an amount between 1 and 10% (w/w), relative to the amount of the binder, and optionally at least one additive, the light-absorbance of the coat or film being at least 90%.

In a film of the invention, the binder material adds up the composition to 100%. Thus, in some embodiments, the film comprises between 99% and 90% binder material. For example, where the film comprises 1% of the light absorbing material, the binder material constitutes 99% of the film. Similarly, where the film comprises 7% of the light absorbing material, the binder material constitutes 93%.

In some embodiments, the invention provides a substrate coated with a film of at least one binder, e.g., a ceramic material, and at least one light-absorbing material, e.g., carbon nanotube (CNT), wherein the at least one light-absorbing material constitutes at least 1% (w/w) of the film. In some embodiments, the film has an absorbance of 90%, 91%, 92%, 93%, 94%, 95%, 96%, 97%, 98% or 99%. In other embodiments, light absorbance is of between 90% and 99%, between 90% and 98%, between 90% and 97%, between 90% and 96%, between 90% and 95%, between 90% and 94%, between 90% and 93%, between 90% and 92% or between 90% and 91%.

The at least one “light-absorbing material” is a material capable of absorbing solar radiation, thus forming a “black coat” on a surface region of the substrate. In some embodiments, the material absorbs light in the ultraviolet and visible spectrum as well as in the longer or far-infrared bands. The light absorbing material is selected to afford at least 90% absorbance (absorptivity above 0.90). In some embodiments, the light absorbing material is selected to provide an absorbance of 90%, 91%, 92%, 93%, 94%, 95%, 96%, 97%, 98% or 99%. In other embodiments, the light absorbing material is selected to provide absorbance of between 90% and 99%, between 90% and 98%, between 90% and 97%, between 90% and 96%, between 90% and 95%, between 90% and 94%, between 90% and 93%, between 90% and 92% or between 90% and 91%.

In some embodiments, in the visible range (380-750 nm), light absorbance is at least 96%. In some embodiments, in the NIR range (700-1,000 nm), light absorption is at least 96%. In some embodiments, at a wavelength of between 1,000-1,700 nm, light absorbance is at least 94%, and is at least 93% at a wavelength range of 1,700-2,500 nm.

In some embodiments, the light absorbing material is a carbon allotrope. In further embodiments, the light absorbing material is selected from carbon nanotubes (CNTs), graphene and fullerenes. In some embodiments, the light-absorbing material is CNT.

As used herein, the term “carbon nanotubes (CNTs)” refers to multi-walled CNTs as well as to single-walled CNTs and double-walled CNTs and to mixtures thereof. The CNTs utilized in accordance with the present invention may vary in length, ranging from between about 1 micron to about 500 microns. The CNTs may also be selected amongst such being less than about 1 micron in length, or greater than 500 microns.

In some embodiments, the CNTs are selected to have a length from about 1 micron to about 10 microns, from about 5 to 70 microns, from about 10 to about 100 microns or from about 100 to about 500 microns.

In some embodiments, the CNTs utilized in elements of the invention vary in size (length and/or diameter) and composition.

In some embodiments, an element of the invention comprises a substrate coated on at least a region thereof with a coat or film of at least one binder material which comprises or contains or embeds CNT in an amount between 1 and 10% (w/w), relative to the amount of the binder, and optionally at least one additive, the light-absorbance of the coat or film being at least 90%.

To address the need for utilizing CNTs as light absorbing materials in elements of the invention, the question of nanotube growth from gas phase on the element surfaces was considered. In the course of research it was determined that best results were obtained when CNTs were utilized in an amount of between 1% and 10% w/w in the coating, embedded in a solid binder material, which at one hand could maximize adhesion of the CNTs to the surface and at the same time did not substantially affect stray light suppression or light absorption.

CNT grown on the surface without a solid binder exhibited poor adhesion, irrespective of the orientation of the CNTs on the surface. When CNTs were utilized as part of a sticking layer, e.g., in the form of a thin film of a binder material, in which the CNTs were embedded, as a random distribution of CNTs, which may or may not be co-aligned with the surface, the method was found straightforward and free of deteriorating effects impacting CNT constitution, adhesion and stray light suppression. In a coat or film of the binder material and CNTs are presented as a blend of the two materials, the CNTs not being typically oriented vertically (perpendicularly) to the surface.

The “binder material” is typically a material capable of associating, binding or permitting association between the surface of the substrate and the at least one light absorbing material. The binder material is typically selected amongst inorganic materials configured to receive a dispersion of the at least one light-absorbing material. In some embodiments, the binder material is a heat resistant ceramic material.

In accordance with the present invention, the binder material is selected amongst ceramic materials characterized by high thermal stability (service temperatures above, e.g., 300° C.), low shrinkage, high stability of shape and high dimensional accuracy. The ceramic materials are typically selected amongst inorganic-organic polymers or monomers, such as polysiloxanes, polyborosiloxane, polysilazane, methyl trimethoxysilane and alumina precursors. The formation of ceramic material is based on thermal curing of the functionalized resins at temperatures above 300° C.

The binder material may contain at least one additive, such as dispersing, rheological and wetting agents.

In some embodiments, the binder is thermally formed into a ceramic matrix which comprises the at least one light-absorbing material. Thus, a composite useful in the manufacture of films of the invention comprises at least one binder material in a non-polymerized form, at least one light-absorbing material and optionally at least one additional additive, the composite being transformable into the ceramic matrix by thermal treatment at a temperature above 300° C. The non-polymerized binder material is selected amongst silicon-based material such as polyborosiloxane, polysilazane, methyl trimethoxysilane polycarbosilane, silazane and polysiloxanes.

In some embodiments, the silicon-based material is selected from polyorganosiloxane-based compound, a polycarbosilane-based compound, a polysilane-based compound, a polysilazane-based compound, and the like.

In some embodiments, the silicon-based material is a polysiloxane-based compound. In some embodiments, the material is PDMS.

In some embodiments, the silicon-based material is selected from precursor components comprising one or more reactive silicone containing polymers (and/or oligomers or formulations comprising same). Non-limiting examples of silicone containing polymers include linear or branched polysiloxanes with multiple reactive groups such as Si—H (silicon hydride), hydroxy, alkoxy, amine, chlorine, epoxide, isocyanate, isothiocyanate, nitrile, vinyl, or thiol functional groups.

In some embodiments, the silicon-based material is selected from trimethoxymethyl silane, methyltrimethoxysilane and polysiloxane.

In some embodiments, the silicon-based material is selected from polysilane-based compounds, including homopolymers such as a polydialkylsilane (such as polydimethylsilane, poly(methylpropylsilane), poly(methylbutylsilane), poly(methylpentylsilane), poly(dibutylsilane), and poly(dihexylsilane)), a polydiarylsilane (such as poly(diphenylsilane)), a poly(alkylarylsilane) (such as poly(methylphenylsilane)); copolymers such as a copolymer of a dialkylsilane and another dialkylsilane (such as dimethylsilane-methylhexylsilane copolymer), an arylsilane-alkylarylsilane copolymer (such as phenylsilane-methylphenylsilane copolymer), and a dialkylsilane-alkylarylsilane copolymer (such as dimethylsilane-methylphenylsilane copolymer, dimethylsilane-phenylhexylsilane copolymer, dimethylsilane-methylnaphthylsilane copolymer, and methylpropylsilane-methylphenylsilane copolymer); and the like.

In some embodiments, the polymerized ceramic coating or film comprising the at least one light-absorbing material, e.g., CNT, is at least 1 μm thick. In some embodiments, the coating is at most 20 μm thick. In some embodiments, the coating is between 1 and 20 μm thick. In some embodiments, the coating is 1, 2, 3, 4, 5, 6, 7, 8, 9, 10, 11, 12, 13, 14, 15, 16, 17, 18, 19 or 20 μm thick.

In some embodiments, the coating is between 1 and 2 μm thick. In some embodiments, the coating is between 1 and 5, between 1 and 4, between 1 and 3 μm thick.

In some embodiments, the coating is between 1.5 and 2.1 μm thick. In some embodiments, the coating is between 1.9 and 2.1 μm thick. In some embodiments, the coating is between 3.7 and 4 μm thick.

In some embodiments, the coating on the substrate is of a ceramic material embedding, e.g., CNT, the material ratio between the ceramic material and the CNT being between 1:1 and 3:1.

In some embodiments, the invention provides a substrate coated with a film of at least one binder, e.g., a ceramic material, and at least one light-absorbing material, e.g., carbon nanotube (CNT), the coat being between 2 and 5 μm thick, wherein the at least one light-absorbing material constitutes at least 1% (w/w) of the film and wherein the coat having an absorbance of at least 90%.

From the examples provided herein, it is clear that CNT absorbs solar light strongly and reflects weakly, thereby providing a superior candidate as solar light absorber. However, in solar energy conversion applications, a coating of CNT may suffer from radiative emissivity in the IR region, which results in overheating of the layer of material serving as an absorbing surface, and thus, in an increase of heat loss by convection, heat transfer and re-emission of additional heat by the surface.

Thus, for solar energy conversion applications, in order to inhibit the radiative emission of CNT coatings in the IR region and make the coating selective for solar-thermal conversion, two approaches have been utilized: (1) modifying the type of the binder, the ratio between the binder and CNT, thus forming a concentration gradient of the CNT throughout the deposited layer; and (2) adding an additional coating layer on top of the CNT absorbing layer. The layers may be different coating formulations for each layer, or by combining several functional additives within one or more coating layers.

Without being bound by theory, the emissivity of the CNT coating depends on the type of the binder used in the formulation process. Al₂O₃, trimethoxymethyl silane, and Ren 100 (resulting in silica and silicon containing polymers) were tested as binders and Baytube and Nanoyl tube were tested as absorbing materials.

In some embodiments, inhibition of the radiative emission of the CNT in the IR region was achieved by coating the CNT layer with a material transparent to solar region but which reflects light in the IR region.

Thus, in such embodiments, the binder/CNT coating is further provided with an infrared (IR) reflecting layer; thus providing on the substrate a bilayer comprising:
a first layer of a composite comprising at least one binder material, e.g., a ceramic material and at least one light-absorbing material; and
a second layer comprising an infrared (IR) reflecting material; the second layer being most exposed top layer.

The bilayer exhibits the inverse tandem ability to absorb substantially all stray light, as defined herein, and the ability to internalize evolved IR (thermal) radiation, thereby reducing the radiative emission in the IR region. Thus, a film of the invention may be regarded as an ‘inverse tandem absorbing’ material, being transparent in the solar region but reflecting light in the IR region.

Thus, the “infrared (IR) reflecting material” is a material transparent to solar radiation but capable of reflecting IR radiation. The material is selected from SnO₂, In₂O₃, In doped SnO₂ (ITO), Sb doped SnO₂ (ATO), Cd₂SnO₄, SiC, GaN, AlN, BN, HfC and LaB₆.

In some embodiments, the IR reflecting material is or comprises ITO.

The layer of the IR reflecting material is typically of a thickness between 400 and 3,000 nm, 500 and 3,000 nm, 600 and 3,000 nm, 700 and 3,000 nm, 800 and 3,000 nm, 900 and 3,000 nm, 1,000 and 3,000 nm, 1,100 and 3,000 nm, 1,200 and 3,000 nm, 1,300 and 3,000 nm, 1,400 and 3,000 nm, 1,500 and 3,000 nm, 1,600 and 3,000 nm, 1,700 and 3,000 nm, 1,800 and 3,000 nm, 1,900 and 3,000 nm, 2,000 and 3,000 nm or 2,500 and 3,000 nm.

In some embodiments, the thickness of the IR reflecting layer is at least 400 nm, 500, 600, 700, 800, 900, 1,000, 1,100, 1,200, 1,300, 1,400, 1,500, 1,600, 1,700, 1,800, 1,900, 2,000 or 2,500 nm.

In some embodiments, the bilayer comprising a first layer of a composite comprising at least one binder material, e.g., a ceramic material and at least one light-absorbing material, e.g., CNTs; and a second layer comprising an infrared (IR) reflecting material has emissivity below 0.8 at the NIR range. In some embodiments, the emissivity is below 0.7, below 0.6, below 0.5, below 0.4, below 0.3, below 0.2, below 0.1, below 0.05, below 0.01 or below 0.005 at the NIR range.

In some embodiments, the emissivity is between 0.1 and 0.5. In some embodiments, the emissivity is between 0.1 and 0.4. In some embodiments, the emissivity is between 0.1 and 0.3.

In some embodiments, the coated surface may further comprise an anti-reflective layer comprising an anti-reflective material selected from silane, siloxane, silica, alumina, silicon carbide, hafnium carbide, gallium nitrate, aluminum nitrate, boron nitrate, SnO₂, Cd₂SnO₄, In₂O₃ and LaB₆.

Thus, the invention further provides a bilayer, as defined herein, on a surface region of a substrate, wherein each of the layers may be independently and optionally defined as herein.

The bilayer may be further provided with at least one further coating or layer.

The substrate onto which the ceramic coating or the bilayer is formed is selected of a material such as a metal, glass, an inorganic semiconductor material, a polymeric material and a ceramic material. The substrate may be a two-dimensional substrate or a three-dimensional substrate. The coating with the ceramic coating or with the bilayer may be on any region of the substrate surface, which may be planar or three-dimensional.

In some embodiments, the substrate or a surface of the substrate is of a material selected from a metal, glass, an inorganic or organic semiconductor material, a polymeric material and a ceramic material. In some embodiments, the substrate or a surface of the substrate is made of or contains at least one metal. In some embodiments, the metal is selected from aluminum, stainless steel, gold, silver and copper.

In some embodiments, the substrate or a surface of the substrate is aluminum.

The coating formed on a surface of the substrate may be a continuous pattern of a predetermined size and shape, which may or may not cover the full surface of the substrate. In some embodiments, the substrate is fully covered with a coat of the invention. In other embodiments, multiple patterns are formed on the surface, in spaced-apart regions thereof.

The coated surface is characterized by at least one or more of the following:

(a) emissivity below 0.8 in the NIR range;

(b) absorptivity above 0.90;

(c) adhesion above 90% or having adhesion classification according to ASTM D3359 in the range of OB-3B or according to ISO 2409 Class 5-2;

(d) reflectivity below 7% in the NIR range (850-2,400 nm); and/or

(e) thermal stability at a temperature above 300° C.

In some embodiments, the coated surface is characterized by emissivity below 0.8, 0.6, 0.5, 0.4, 0.3 or 0.25 in the NIR range. In some embodiments, the coated surface has reflectivity below 7% in the NIR range.

In some embodiments, the element of the invention for use in the suppression of stray light comprises a ceramic material embedding a plurality of CNTs, the element being characterized by emissivity below 0.8 in the NIR range; absorptivity above 0.90; adhesion above 90%; and reflectivity below 7% in the NIR range.

In some embodiments, the element of the invention for use in the suppression of stray light comprises a ceramic material embedding a plurality of CNTs, the element being characterized by emissivity below 0.8 in the NIR range and absorptivity above 0.90.

In some embodiments, the element of the invention for use in the reflection of IR radiation comprises a ceramic material embedding a plurality of CNTs and a coat of at least one IR reflecting material, such as ITO, the element being characterized by emissivity below 0.8 in the NIR range; adhesion above 90%; and reflectivity below 7% in the NIR range.

In some embodiments, the element of the invention for use in the reflection of IR radiation comprises a ceramic material embedding a plurality of CNTs and a coat of ITO, the element being characterized by emissivity between 0.1 and 0.5 in the NIR range and absorptivity above 0.90.

The substrate coated in accordance with the invention may be a substrate of a surface of a device or an instrument selected in general terms from optical, electronic and optoelectronic devices. Each of the elements of the invention may be utilized as components utilized in the construction of an optical, electronic or optoelectronic device. The device may be selected from an electronic device, optical device, an optoelectronic device, a photothermal device, an energy conversion device, a solar cell device and a satellite. In some embodiments, the device is selected from a photothermal device, an energy conversion device such as thermosolar device, and an optical device. The thermosolar device can be used for generating electricity through generators, or for heating liquids such as water.

In some embodiments, the thermosolar device is selected from solar panels (e.g., water panels and building panels) and photovoltaic devices.

In some embodiments, the device is or comprises a solar radiation absorber.

Thus, the invention further provides a device comprising a substrate coated with at least one light-absorbing layer, the absorbing layer comprising a ceramic material and at least one light-absorbing material, wherein said at least one light-absorbing layer is optionally coated with a film of at least one solar radiation transparent and IR radiation reflecting layer.

The invention provides a thermosolar device comprising an element according to the invention. In some embodiments, the device is or comprises a solar panel. In some embodiments, the solar panel is selected amongst thermosolar water panels and thermosolar building panels. In some embodiments, the device is utilized for generating electricity or for heating a liquid.

Similarly, elements of the invention may be used in satellite optics, satellite star-tracking, space telescopes, missile seeker devices, IR optical systems, cameras, microscopes, digital cinema cameras and thermal solar collectors.

The invention further provides a method of fabricating an absorbent coating on a surface region of a substrate, the method comprising:
(a) forming on a surface region at least one absorbing layer comprising:
   (i) a light-absorbing material;
   (ii) a polymerizable binder resin;
(b) heating said at least one absorbing layer to induce polymerization and conversion into a heat resistant material of said binder resin; and
(c) optionally forming at least one IR radiation reflecting layer on said polymerized binder.

In some embodiments, the at least one IR radiation reflecting layer comprises a material selected from SnO₂, In₂O₃, In doped SnO₂ (ITO), Sb doped SnO₂ (ATO), Cd₂SnO₄, SiC, GaN, AlN, BN, HfC and LaB₆.

In some embodiments, the method further comprises annealing said at least one IR radiation reflecting layer.

In some embodiments, the forming of layer (a) is carried out by wet deposition. In some embodiments, the wet deposition is selected from spin coating, roll coating, coil coating, dip coating and spray deposition. In some embodiments, the wet deposition is spray deposition of a dispersion comprising at least one light-absorbing material and at least one polymerizable binder.

In some embodiments, layer (c) is formed by wet deposition or by sputtering deposition. In some embodiments, the wet deposition is spray deposition of a mixture comprising at least one ceramic polymer precursor and optionally a binder in a solvent.

The invention further provides an ink formulation comprising at least one light-absorbing material, at least one polymerizable binder resin and at least one additive selected from a dispersant, a surfactant, a wetting agent, and a rheological agent. The formulation may further comprise at least one solvent (selected amongst organic solvents and aqueous media).

In some embodiments, the formulation is adapted or suited for use in a method for fabricating a device for light suppression. In further embodiments, the formulation is adapted or suited for use in a method for fabricating a thermosolar device.

In some embodiments, the formulation is used in a method for fabricating a ceramic film on a surface region. In some embodiments, the at least one polymerizable binder resin is selected to thermally transform into a ceramic material, the transformation being optionally achievable by thermal treatment at a temperature above 300° C. The at least one polymerizable binder resin is selected amongst silicon-based materials such as polyborosiloxane, polysilazane, methyl trimethoxysilane polycarbosilane, silazane and polysiloxanes.

In some embodiments, the at least one light-absorbing material is selected as above, being preferably, in further embodiments, CNT.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1(a). Black coating on glass (left) and aluminum surface (right) achieved by wet deposition (spray coating) of the MWCNT formulation, and (b) adhesion test of CNT-binder formulation coated on aluminum substrate according to Example 1: the tape (left) and the coating (right) after the test.

FIG. 2. (a) Light absorption spectrum and (b) light reflectance spectrum (NIR range) of CNT-binder coated on aluminum substrate according to Example 1 of the present disclosure.

FIG. 3. (a) Light absorption spectrum and (b) light reflectance spectrum (NIR range) of CNT-binder formulation coated on aluminum substrate according to Example 2 of the present disclosure.

FIG. 4. (a) Light reflectance spectrum (VIS-NIR range) and (b) Light reflectance spectrum (NIR range) of CNT-binder formulation coated on aluminum substrate according to Example 3 of the present disclosure.

FIG. 5(a). Light absorption spectrum of CNT-binder formulation coated on aluminum substrate according to Example 4 of the present disclosure.

FIG. 5(b). Adhesion test of CNT-binder formulation coated on aluminum substrate according to Example 4: the tape (left) and the coating (right) after the test.

FIG. 6. Light reflectance spectrum (VIS-NIR range) of CNT-binder formulation coated on aluminum substrate according to Example 7 of the present disclosure.

FIG. 7. Light reflectance spectrum (VIS-NIR range) of CNT-binder formulation coated on aluminum substrate according to Example 8 of the present disclosure.

FIG. 8. Light reflectance spectrum (IR range) of CNT-binder formulation coated on aluminum substrate according to Example 9 of the present disclosure.

FIG. 9. Scheme illustrating the fabrication of CNT/ITO coating on Al substrate.

FIG. 10. SEM images of (a) CNT, (b) CNT/ITO^{sputterd}, and (c) CNT/ITO^{sprayed} coatings.

FIG. 11. EDS spectra of (a) CNT, (b) CNT/ITO^{sputterd}, and (c) CNT/ITO^{sprayed} coatings.

FIG. 12. XRD pattern of CNT, CNT/ITO^{sputterd} CNT/ITO^{sprayed} coatings.

FIG. 13. Reflectance spectra of CNT coating on Al substrate. Inset shows the reflectance spectra of Al substrate alone (no coat).

FIG. 14. Reflectance spectra of CNT/ITO^{sputtered} and CNT/ITO^{sprayed} coatings.

FIG. 15. (a) Variation of absorptance and emittance with the ITO layer thickness and (b) reflectance spectra of CNT/ITO^{sputtered} coatings with varying thickness of ITO layer.

FIG. 16. Sheet resistance of CNT/ITO^{sputtered} coatings with varying thickness of ITO layer.

FIG. 17. Adhesion tests of: (a) CNT, (b) CNT/ITO^{sputterd}, and (c) CNT/ITO^{sprayed} coatings.

FIG. 18. Absorptance and emittance of CNT/ITO^{sputterd} coating at: (a) different temperature at 6 hr of time and (b) different time at 250° C.

FIG. 19. Scheme illustrating the fabrication of ‘inverse tandem’ absorbing coating CNT/ITO in solar spectrum region.

FIG. 20. SEM images of different BT/binder coatings (a) before curing and (b) after curing.

FIG. 21. TGA-MS analysis of binder under thermal treatment. Curing starts after 200° C. with the release of —OH fragments and H₂O molecules from the binder matrix.

FIG. 22. (a) Effect of BT and binder concentrations and (b) NC and binder concentrations on coating reflectance in the VIS range.

FIG. 23. MWCNT (NC type) coatings, after cross cut and tape test.

FIG. 24. Optical device internal piece before and after spray coating the MWCNT ink.

### DETAILED DESCRIPTION OF EMBODIMENTS

### Methods of Characterization of Coated Structures

### Experimental Techniques

### Structure and Morphology Characterization

Structure and morphology were acquired using high resolution scanning electron microscopy (HR-SEM, Sirion, XL30FEG) and stereo microscope (SQF II, China).

### Compositional Analysis

For compositional analysis, energy dispersive X-ray spectroscopy (EDX) measurements were performed.

XRD measurements were performed with D8 Advance diffractometer (Bruker AXS, Karlsruhe, Germany) equipped with Göbel Mirror parallel-beam optics with CuKα radiation (λ=1.54 Å).

### Thickness Measurements

Thickness of the coatings was measured with micro-TRI-gloss μ (BYK Gardner GmbH, Germany)

### Optical Measurements (Reflectance and Absorptance)

Reflectance spectra were recorded with a CARY 5000 UV-visible-NIR spectrophotometer (Varian, USA).

The absorptance of the coatings were calculated from the UV-vis-NIR reflectance spectra using the equation; α+R+T=1, where α is absorptance, R is reflectance, and T is transmittance. Since the coatings were fabricated on Al substrate, the transmittance is zero and therefore the absorptrance α=1−R.

Emittance was measured with Emissometer AE1/RD1 (Devices & Services Co, Dallas, Tex., USA).

### Resistance Measurements

Sheet resistance was measured with four-point probe Cascade Microtech (Beaverton, USA) coupled to an Extech milliohm meter (model 380562, Waltham, USA).

### Spectral Selectivity

In order to attain a tuneable spectral selectivity, coatings of ITO with different thicknesses were fabricated by sputtering on top of the CNT coatings.

Sputtering was carried out with FHR, Analgenbau GMBH, MS 75X4-L.

### Adhesion Tests

The adhesion test was performed on both CNT coating as well as CNT/ITO coating prepared by both sputtering and spraying. The tests were conducted by Cross-Cut-Tester 1 mm according to standards ASTM D 3359 and ISO 2409. In this test, a lattice pattern is cut into the coating penetrating through the substrate. A tape is placed on the cut pattern and then pealed. The coating area is observed and the adhesion is rated in accordance with standard scale.

### Temperature Stability Tests

The performance evaluation of CNT/ITO^{sputtered} coating was carried out by subjecting them to heat storage in air at various temperatures and time durations. The absorptance and emittance of the coatings were measured after cooling down to room temperature.

### Materials and Methods of Preparation

### Obtaining Absorbing Layer from CNT-Based Dispersion

### Example 1

### Coating Formed from Dimethylformamide (DMF)-Based Dispersion Comprising CNT and Silres REN-60

### Absorbing Layer Preparation

500 mg of CNT (Baytubes cp70, Bayer Material Science, Germany) and 500 mg of 10% dispersing agent (Byk⁹⁰⁷⁷, Byk-Chemie GmbH, Germany) were mixed in 49 g of DMF (Merck). The mixture was sonicated for 20 minutes at 750 W in pulses of one second on and one second off. Then, 5 g of silicon resin Silres REN-60 (polysiloxane, Waker Chemie AG, Germany) was added to the dispersion and then the dispersion was sonicated for 5 minutes. The coating was prepared by spraying of the above dispersion on heated (100° C.) substrate. The samples were dried at 70° C. and then cured at 350° C. for two hours.

The liquid dispersion containing CNT and polysiloxane was converted into a heat-stable ceramic matrix upon curing.

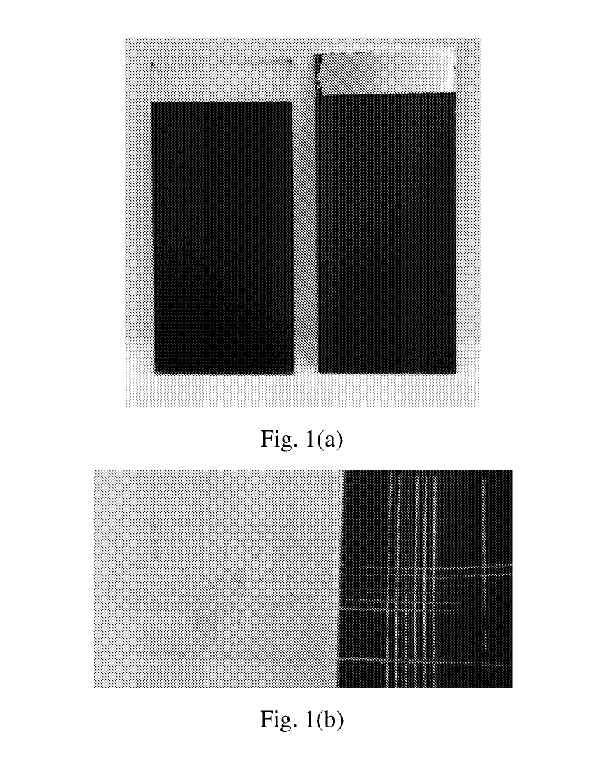

The absorbing black layer according the Example 1 coated on glass (left) and on aluminum surface (right) achieved by wet deposition (spray coating) is displayed in FIG. 1(a).

### Adhesion Tests

Adhesion test of the CNT-binder coating on aluminum according to Example 1 is displayed in FIG. 1(b). The tape (left) and the coating (right), after the test, is shown in the figure. The adhesion of the CNT coating on aluminum substrate according the Example 1 corresponds to ISO class 0. The edges of the cuts are completely smooth, and a cross cut area near 0% is affected.

### Optical Measurements

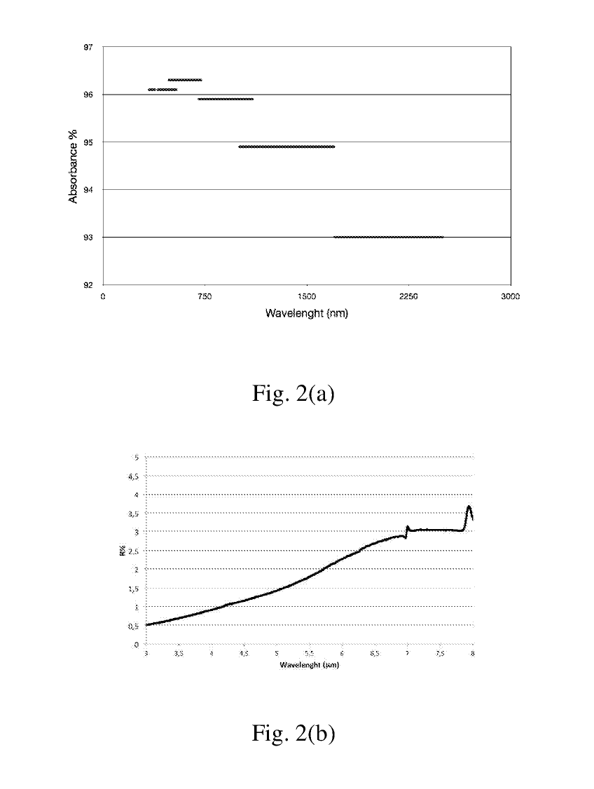

In the visible range (wavelength 380-750 nm) the absorbance reached over 96%. In the NIR, the absorption reached over 96% at the range of 700-1000 nm, over 94% at the range of 1000-1700 nm, and 93% at the range of 1700-2500 nm (displayed in FIG. 2(a)).

The absorbing layer coated on aluminum substrate according to Example 1 exhibits high absorbance properties in the Vis-NIR range. The thickness of the coatings shows a very minor effect on the light absorption, decreasing from 96.94% in coatings with a thickness of about 1.9-2.1 μm, to 95.90% in coatings with a thickness of 15-15.5 μm (the results are summarized in Table 1).

TABLE 1
The effect of coating thickness on the light absorption

| | % Vis-NIR | Coating |
|---|---|---|
| Substrate | absorption | thickness |
| Glass | 96.94% | 1.9-2.1 μm |
| Glass | 96.72% | 3.7-4.0 μm |
| Glass | 95.89% | 6.5-6.7 μm |
| Glass | 95.90% | 15-15.5 μm |
| Aluminum | 96.29% | 1.9-2.1 μm |
| Aluminum | 96.23% | 3.7-4.0 μm |
| Aluminum | 95.79% | 6.5-6.7 μm |
| Aluminum | 95.60% | 15-15.5 μm |

The absorbing layer coated on aluminum substrate according to Example 1 shows high performance in absorbing NIR light in order to absorb and reduce the unwanted stray light in optical systems. The light reflected (R %) reached less than 8% (wavelength range 3-10 μm), particularly reaching a low value of less than 2% at the wavelength range 3-5 μm (displayed in FIG. 2(b)).

### Example 2

### Coating Formed from Dimethylformamide (DMF)-Based Dispersion Comprising CNT and Silikophen P 80/MPA

### Absorbing Layer Preparation

500 mg of carbon nanotubes (short MWCNT from Cheaptubes) and 500 mg of dispersing agent (Byk⁹⁰⁷⁷) were dispersed in 49 g dimethylformamide. The mixture was sonicated for 20 minutes at 750 W in pulses of one second on and one second off. 5 g of the resin Silikophen P 80/MPA was added to the dispersion and sonicated for 5 minutes at 750 W in pulses of one second on and one second off. The coating was prepared by spray deposition on a heated aluminum substrate. The samples were dried on at 70° C. and then cured at 350° C. for two hours.

### Optical Measurements

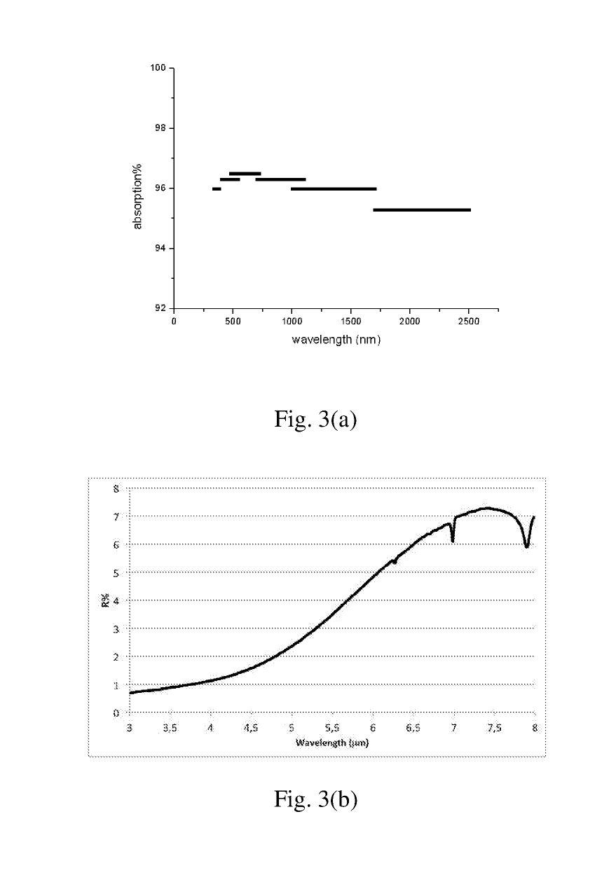

In the visible range (wavelength 380-750 nm) the absorbance reached over 96%. In the NIR, the absorption was 96% at the range of 700-1700 nm and over 95% at the range of 1700-2500 nm (FIG. 3(a)).

The coatings show high performance in absorbing NIR light in order to absorb and reduce the unwanted stray light in optical systems. The light reflected (R %) reached less than 8% (wavelength range 3-8 μm), particularly reaching a low value of less than 3% at the wavelength range 3-5 μm (FIG. 3(b)).

### Adhesion Tests

The CNT coating/aluminum adhesion corresponds to ISO class 0. The edges of the cuts are completely smooth, and a cross cut area near 0% is affected.

### Temperature Stability Tests

The thermal stability was evaluated by storing the coating according to Example 2 at different temperatures (100° C., 200° C., 300° C., 400° C., 500° C.) for 10 hours (displayed in Table 2). The coating showed good stability, maintaining the excellent adhesion and absorbance properties under all the conditions checked.

TABLE 2
Thermal stability of the coating according to Example 2
at various storing temperatures (100° C., 200° C.,
300° C., 400° C., 500° C.) for 10 hours.

| | | % Absorbance |
|---|---|---|
| | % Absorbance | (360-740 nm) |
| | (360-740 nm) | (coating on aluminum |
| Temperature | (coating on aluminum) | with surface treatment) |
| 100° C. | 95.36 ± 0.03 | 96.53 ± 0.04 |
| 200° C. | 95.52 ± 0.04 | 96.53 ± 0.03 |
| 300° C. | 94.97 ± 0.03 | 96.57 ± 0.01 |
| 400° C. | 95.39 ± 0.03 | 96.75 ± 0.05 |
| 500° C. | 95.32 ± 0.02 | 94.69 ± 0.39 |

The stability was evaluated over a various storage period durations at 400° C. The coating according to Example 2 showed good stability, maintaining the excellent adhesion and absorbance properties under all the conditions checked. The absorbance properties, as a function of storage time, are shown in Table 3.

TABLE 3
Thermal stability of the coating according to Example 2
over storing temperature of 400° C. for 10, 20, 30,
40 and 50 hours.

| Storage period | % Absorbance (360-740 nm) |
|---|---|
| 10 hours | 95.39% ± 0.03 |
| 20 hours | 95.35% ± 0.05 |
| 30 hours | 95.39% ± 0.01 |
| 40 hours | 95.42% ± 0.02 |
| 50 hours | 95.51% ± 0.10 |

### Example 3

### Coating Formed from Dimethylformamide (DMF)-Based Dispersion Comprising CNT and Silres REN-60

### Absorbing Layer Preparation

250 mg of carbon nanotubes (Nanocyl NC7000) and 500 mg of dispersing agent (Byk⁹⁰⁷⁷) were dispersed in 49 g dimethylformamide. The mixture was sonicated for 20 minutes at 750 W in pulses of one second on and one second off. 1.25 g of the silicon resin Silres REN-60 was added to the dispersion and sonicated for 5 minutes at 750 W in pulses of one second on and one second off. The coating was prepared by spray deposition on aluminum substrate. The samples were heated at 100° C. for 1 hour at a heating rate of 5° C./min, followed by heating to 300° C. for 30 minutes at a heating rate of 10° C./min, followed by heating to 350° C. for 30 minutes at a heating rate of 10° C./min.

### Optical Measurements

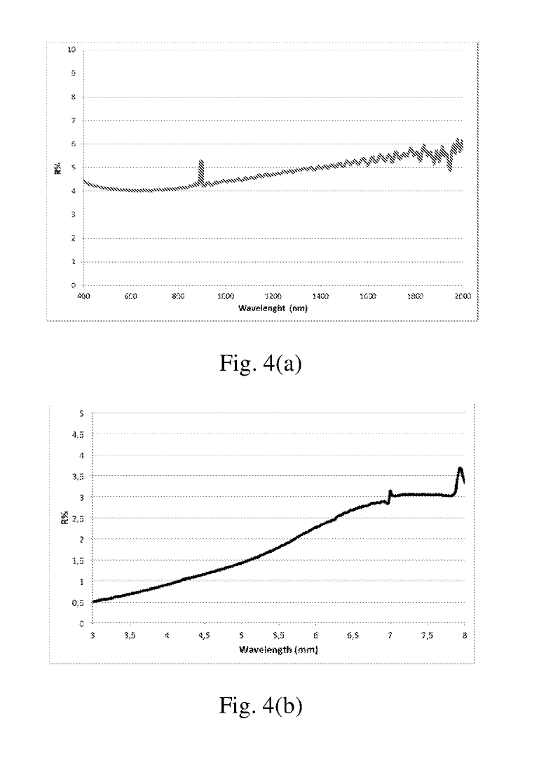

The coatings show high performance in absorbing VIS and NIR light, thus enabling reduction of the unwanted stray light in optical systems. The reflected light (R %) was about 4% in the VIS range (wavelength 380-750 nm) (FIG. 4(a)). In the NIR range (wavelength 3-8 μm), the reflected light (R %) was less than 3%, (FIG. 4(b)).

### Adhesion Tests

For the resulting coating the adhesion on aluminum corresponds to ISO class 0. The edges of the cuts are completely smooth, and a cross cut area near 0% is affected.

### Example 4

### Coating Formed from Water-Propylene Glycol Dispersion Comprising CNT and Alumina

### Absorbing Layer Preparation

200 mg of carbon nanotubes (Baytubes cp70) and 100 mg of a dispersing agent, Solsperse 46000, were dispersed in 15.7 g deionized water mixed with 4 g propylene glycol. The mixture was sonicated for 9 minutes at 750 W in pulses of one second on and one second off. 20 g of 10 wt % alumina solution (Disperal in water) was added to the dispersion and sonicated for 5 minutes. The coating was prepared by spray deposition on aluminum substrate. The samples were heated at 100° C. for 1 hour at a heating rate of 5° C./min, followed by heating to 300° C. for 30 minutes at a heating rate of 10° C./min, followed by heating to 350° C. for 30 minutes at a heating rate of 10° C./min.

### Optical Measurements

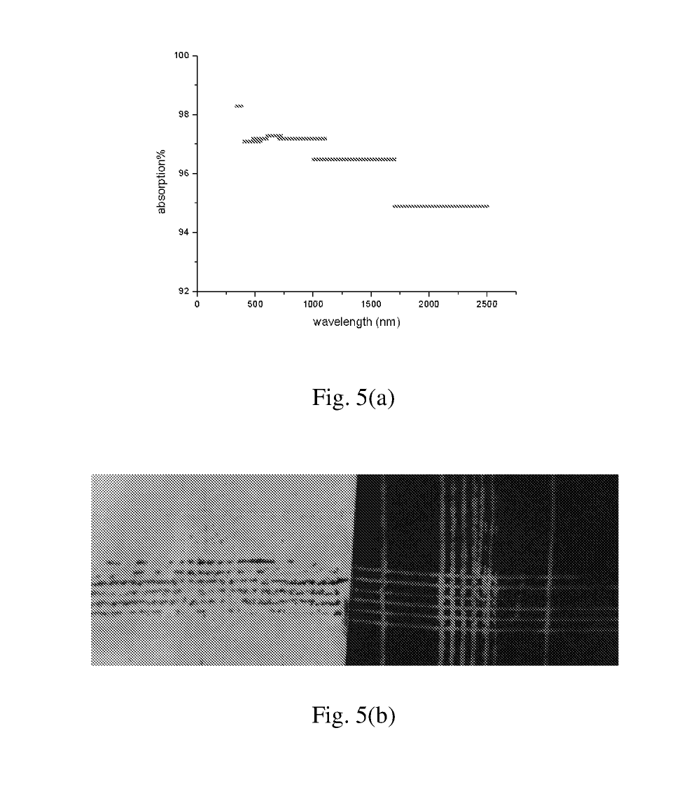

In the visible range (wavelength 380-750 nm) the absorbance of the CNT-binder coated on aluminum according to Example 3 reached over 97%. In the NIR, the absorption could reach over 97% at a range of 700-1000 nm, over 96% at a range of 1000-1700 nm, and 95% at a range of 1700-2500 nm (displayed in FIG. 5(a)).

### Adhesion Tests

The CNT coating adhesion corresponded to an ISO class 3; the coating had flaked along the edges and/or at the intersection of the cuts. A cross cut area between 5-15% was affected (FIG. 5(b)).

### Temperature Stability Tests

The thermal stability the coating according to Example 4 was evaluated by storing the coating at different temperatures (100° C., 200° C., 300° C., 400° C., 500° C.) for 10 hours (displayed in Table 4). The coating showed good stability, maintaining the adhesion and absorbance properties under all the conditions checked.

TABLE 4
Thermal stability of the coating according to Example 4
at various storing temperatures (100° C., 200° C.,
300° C., 400° C., 500° C.) for 10 hours.

| | % Absorbance |
|---|---|
| | (360-740 nm) |
| | (coating on aluminum |
| Temperature | with surface treatment) |
| 100° C. | 97.26 ± 0.05 |
| 200° C. | 97.1 ± 0.014 |
| 300° C. | 96.31 ± 0.06 |
| 400° C. | 97.88 ± 0.05 |
| 500° C. | 97.88 ± 0.02 |

The stability was evaluated for a longer period of time at 400° C. The coating showed good stability, maintaining the adhesion and absorbance properties under all the conditions checked. The absorbance properties as a function of storage time are shown in Table 5.

TABLE 5
Thermal stability of the coating according to Example 4
over storing temperature of 400° C. for 10, 20, 30,
40 and 50 hours.

| Storage period | % Absorbance (360-740 nm) |
|---|---|
| 10 hours | 97.88% ± 0.05 |
| 20 hours | 97.31% ± 0.16 |
| 30 hours | 97.53% ± 0.08 |
| 40 hours | 97.25% ± 0.13 |
| 50 hours | 97.75% ± 0.04 |

### Example 5

### Coating Formed from Water-Propylene Glycol Dispersion Comprising CNT and Alumina—Effect of Coating Thickness on Absorptance

### Absorbing Layer Preparation

200 mg of carbon nanotubes (Baytubes cp70) and 100 mg of a dispersing agent, Solsperse 46000, were dispersed in 15.7 g deionized water mixed with 4 g propylene glycol. The mixture was sonicated for 9 minutes at 750 W in pulses of one second on and one second off. 2 g of 10 wt % alumina solution (Disperal in water) was added to the dispersion and sonicated for 5 minutes. The coating was prepared by spray deposition on aluminum substrate. The samples were cured at 100° C. for 1 hour at a heating rate of 5° C./min, at 300° C. for 30 minutes at a heating rate of 10° C./min, and at 350° C. for 30 minutes.

### Temperature Stability Tests

In the visible range (wavelength 380-750 nm) the coating's absorbance reached over 96%. The coating's thickness did not show any significant effect on the light absorption, remaining at around 96.31-97.19% for coatings where the thickness was about 1.7-5.6 μm.

TABLE 6
Absorptance as a function of thickness of the coating
according to Example 5 over storing temperature of
400° C. for 10, 20, 30, 40 and 50 hours.

| Thickness (μm) | % Absorbance (360-740 nm) |
|---|---|
| 1.774 ± 0.104 | 96.31% |
| 3.06 ± 0.27 | 97.19% |
| 5.61 ± 0.35 | 97.08% |

### Example 6

### Coating Formed from Water-Propylene Glycol Dispersion Comprising CNT and Alumina-Methyltrimethoxysilane—Effect of Coating Thickness on Absorptance

### Absorbing Layer Preparation

16 g methyltrimethoxysilane were mixed with 8 g of 10% alumina solution (Disperal in water). The mixture was homogenized for 5 minutes at a speed of 13,000 rpm and kept at room temperature before use. 320 mg of carbon nanotubes Baytubes cp70 and 160 mg of dispersing agent, Solsperse 46000, were dispersed in 25.12 g deionized water mixed with 6.4 g propylene glycol. The mixture was sonicated for 9 minutes at 750 W in pulses of one second on and one second off. The alumina-methyltrimethoxysilane mixture was added to the CNT dispersion and stirred for 2 hours. The coating was prepared by spray deposition on aluminum substrate. The samples were heated at 100° C. for 1 hour at a heating rate of 5° C./min, followed by heating to 300° C. for 30 minutes at a heating rate of 10° C./min, followed by heating to 350° C. for 30 minutes at a heating rate of 10° C./min

### Optical Measurements

In the visible range (wavelength 380-750 nm), the coating absorbance reached over 96% (not shown here).

### Adhesion Tests

The adhesion of CNT-binder based coating on aluminum substrate corresponds to ISO class 0. The edges of the cuts are completely smooth, and a cross cut area, near to 0%, was affected (not shown here).

### Example 7

### Coating Formed from DMF-Based Dispersion Comprising CNT and Silres REN-100

### Absorbing Layer Preparation

250 mg of carbon nanotubes (Baytubes) and 500 mg of dispersing agent (Byk 9077) were dispersed in 49 g dimethylformamide. The mixture was sonicated for 20 minutes at 750 W in pulses of one second on and one second off. 750 mg of the silicon resin Silres REN-100 was added to the dispersion and sonicated for 5 minutes at 750 W in pulses of one second on and one second off. The coating was prepared by spray deposition on a heated aluminum substrate. The samples were dried on at 70° C. and then baked at 350° C. for two hours.

### Optical Measurements

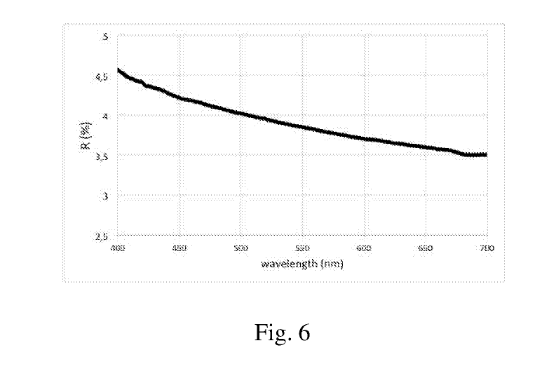

The coatings show high performance in absorbing VIS and NIR light, thus enabling reduction of the unwanted stray light in optical systems. The reflected light (R %) was >4.5% in the VIS range (wavelength 400-700 nm) (FIG. 6).

### Example 8

### Coating Formed from DMF-Based Dispersion Comprising CNT and Low Binder Content (Silres REN-100) in Mixture

250 mg of carbon nanotubes (Baytubes) and 500 mg of dispersing agent (Byk 9077) were dispersed in 49 g dimethylformamide. The mixture was sonicated for 20 minutes at 750 W in pulses of one second on and one second off. 250 mg of the silicon resin Silres REN-100 was added to the dispersion and sonicated for 5 minutes at 750 W in pulses of one second on and one second off. The coating was prepared by spray deposition on a heated aluminum substrate. The samples were dried on at 70° C. and then baked at 350° C. for two hours.

### Optical Measurements

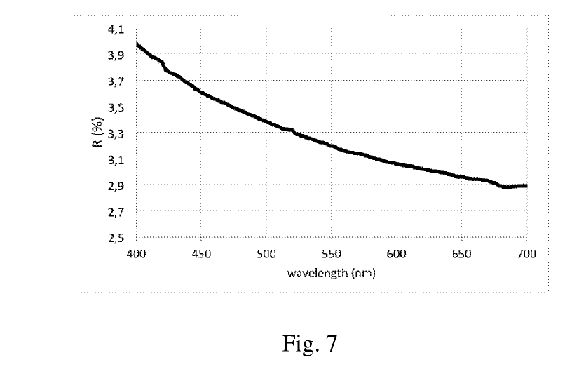

The coating according to Example 8 shows high performance in absorbing VIS and NIR light, thus enabling reduction of the unwanted stray light in optical systems. The reflected light (R %) was >4.0% in the VIS range (wavelength 400-700 nm) (displayed in FIG. 7).

### Example 9

### Coating Formed from DMF-Based Dispersion Comprising CNT and Low Binder Content (Silres REN-100)

250 mg of carbon nanotubes (Baytubes) and 500 mg of dispersing agent (Byk⁹⁰⁷⁷) were dispersed in 49 g dimethylformamide. The mixture was sonicated for 20 minutes at 750 W in pulses of one second on and one second off. 3 g of the silicon resin Silres REN-100 was added to the dispersion and sonicated for 5 minutes at 750 W in pulses of one second on and one second off. The coating was prepared by spray deposition on a heated aluminum substrate. The samples were dried on at 70° C. and then baked at 350° C. for two hours.

### Optical Measurements

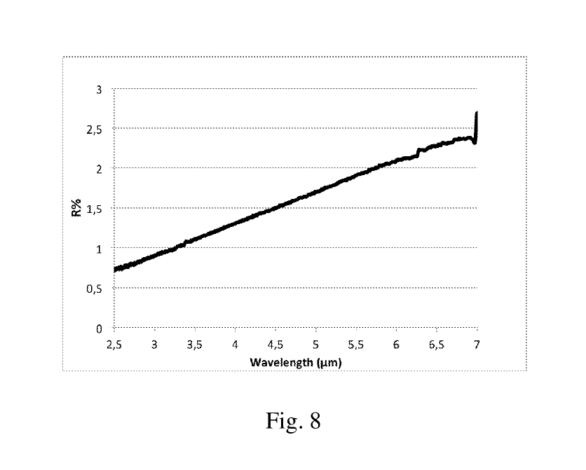

The coating according to Example 8 shows high performance in absorbing VIS and NIR light, thus enabling reduction of the unwanted stray light in optical systems. The reflected light (R %) was >2.5% in the IR range (wavelength 2.5-7 μm) (FIG. 8).

From the above examples, it is very clear that CNT absorbs solar light strongly and reflects weakly, thereby providing a superior candidate for solar light absorber.

However, in solar energy conversion applications, the coating of CNT, may suffer from radiative emissivity in the IR region which results in overheating of the layer of material serving as an absorbing surface, and thus, in an increase of heat loss by convection, heat transfer and re-emission of additional heat by the surface.

A further testing of coating formulations in order to inhibit the radiative emission of CNT coating in the IR region and make this coating selective for solar-thermal conversion is described in the following examples. This approach includes modifying the type of the binder, the ratio between the binder and CNT, forming a concentration gradient of the CNT throughout the deposited layer and adding an additional coating layer below or on top of the CNT absorbing layer. The layers may be different coating formulations for each layer, or by combining several functional additives within one or more coating layer.

Without being bound by theory, the emissivity of the CNT coating depends on the type of the binder used in the formulation process. Al₂O₃, trimethoxymethyl silane, and Ren 100 (resulting in silica and silicon containing polymers) were tested as binders and Baytube and Nanoyl tube were tested as absorbing materials.

### Example 10

### Coating Formed from Water-Propylene Glycol Based Dispersion Comprising Baytube CNT, Al₂O₃ and Trimethoxymethyl Silane

In the first step, 0.06 g of solsphere 46000, 0.12 g of baytube CNT, 4 g of propylene glycol, and 15.82 g of water are mixed in a 28 ml vial and sonicated for 3.5 min at 750 W with amplitude of 85% and in pulse of one second on and one second off.

In the 2^{nd} step, binder was prepared by mixing 2 g of 10% Al₂O₃ and 1 g of trimethoxysilane and stirred for 2.5 hr at 820 rpm.

In the 3^{rd} step, 0.1 g of Byk333, 1.25 g of binder from the 2^{nd} step and 8.75 g of CNT dispersion from the 1^{st} step are mixed and stirred for 5 hr at 820 rpm. The coating was prepared on an Al substrate by spraying of the mixture obtained from the 3^{rd} step and then heated in an oven at 100° C. for 30 min with rate of 5° C./min, then at 250° C. for another 30 min with rate of 10° C./min and then finally at 350° C. for one hour with the rate of 10° C./min.

The coating exhibited emissivity in the range of 0.87-0.88.

### Example 11

### Coating Formed from Dispersion Comprising Nanocyl CNT and REN 168

1 g Byk 9077 was mixed in 10% DMF solution, 0.1 g of nanocyl CNT and 18 g of DMF in a 28 ml vial and sonicated for 10 min at 750 W with amplitude of 85% and in pulse of two second on and one second off. After sonication, 6 g of REN 168 of 10% DMF solution was added to the mixture and sonicated in bath sonicator for 10 min. The coating was prepared by spraying the formulation on a heated Al substrate and then heated in oven at 350° C. for 2 hr.

The coatings exhibited emissivity in the range of 0.77-0.78.

### Example 12

### Coating Formed from Dispersion Comprising Baytube CNT and REN 168

2 g of Byk 9077 was mixed with 10% DMF solution, 0.2 g of baytube CNT and 18 g of DMF in a 28 mL vial and sonicated for 10 min at 750 W with amplitude of 85% and in pulse of two second on and one second off. After sonication, 6 g of REN 168 of 10% DMF solution was added to the mixture and sonicated in bath sonicator for 10 min. The coating was prepared by spraying the formulation on a heated Al substrate and then heated in oven at 350° C. for 2 hr.

The coatings show the emissivity in the range of 0.77-0.78.

As appreciated from Examples 10-12, REN 168 binder decreases the emissivity by 12% in comparison to Al₂O₃ and trimethoxymethyl silane as binder.

Without being bound by theory, the decrease in emissivity in the case of REN 168 may be due to its inherent IR reflective property compared to Al₂O₃ and trimethoxymethyl silane mixture. These results indicate that changing the type of binder may affect the emissivity of the coating.

### Example 13

### Gradient Absorbent Layer Coating Formed from Dispersion Comprising CNT and Ren 100

Additional approach to decreasing the emissivity according to the present disclosure is by providing a gradient coating on a substrate. The 1^{st} layer comprises 1:3 (wt %/wt %) ratio of CNTs and REN 168. A 2^{nd} and 3^{rd} layer comprises 1:2 and 1:1 (wt %/wt %) of CNTs and REN 168 was coated on the 1^{st} layer.

Example 13 was prepared using the same procedure as in the case of Example 12, only with the change in the amount of Ren 100. For 2^{nd} layer, 4 g of Ren 100 and for 3^{rd} layer, 2 g of REN 168 was used.

The coatings show emissivity in the range of 0.73-0.74.

As appreciated from Example 13 (gradient layer) in comparison with Example 12 (non-gradient layer), there is a decrease in the emissivity of gradient coating of CNT compared to only one layer of coating.

### Obtaining Transparent Conducting Layer on Absorbing Layer Comprising CNT-Binder Matrix

### Example 14

### Transparent Conducting Layer Coating on Absorbent Layer

Additional approach is to use a layer which is transparent to solar region but reflects light in the IR region on the layer on top of the CNTs coating. Such materials, which are transparent in the solar region but reflect light in the IR region, may significantly reduce the radiative emission in the IR region. A material with wide band gap, may reflect light in the IR region. The wide band gap materials may include: SnO₂, In₂O₃, In doped SnO₂ (ITO), Sb doped SnO₂ (ATO), Cd₂SnO₄, SiC, GaN, AlN, BN, HfC, LaB₆, etc.

Among these materials, SnO₂, In₂O₃, ITO, and ATO as top layer coating was tested. However, this approach can be applied with various materials that have the suitable band gap and refractive index.

This coating was carried out by spray coating or sputtering of formulations containing nanoparticles or precursor for the required material and by sputtering process. The coating thickness can be controlled according to the applied deposition method, to yield the minimal emissivity.

ITO is a candidate for top layer coating because of its stability at high temperature, high carrier concentration, and low sensitivity to moisture.

ITO Coating by Sputtering:

The coating of ITO with different thickness on top of the CNT layer was performed by magnetron sputtering for various durations and the samples are termed CNT/ITO^{sputterd}.

ITO Coating by Spraying:

First, 0.08 g of Sn(acac)₂Cl₂, was dissolved in 8 ml of DMF. To this solution, 0.8 g of In(acac)₃, and 0.2 ml of HCl (concentrated) was added and stirred for 2 hr. Then 0.1% of Byk⁹⁰⁷⁷ was added to the reaction mixture and stirred for another 20 min 1-1.5% of silicon resin Silres REN-168 was added to the mixture and stirred for another 10 minute. The reaction mixture (2 ml) was sprayed on the CNT layer, which was heated to 120° C. The sample was annealed at 450° C. in air for 40 min and then under N₂ for 1 hr. These coatings are termed CNT/ITO^{sprayed}.

In the 1^{st} step CNT coating was prepared according to the procedure of Example 12 and then in the 2^{nd} step, coating of ITO of 10, 50, 100, 150, 200, 400, 800, and 1200 nm thickness on CNT coating was fabricated by sputtering process.

The coatings show emissivity in the range of 0.8-0.2.

### Example 15

### Transparent Conducting Layer Coating on Absorbent Layer Comprising Baytubes CNT and REN-168 (Polysiloxane) as Binder

0.2 g of CNT (Baytubes cp70) and 2.0 g of 10% dispersing agent (Byk⁹⁰⁷⁷) were mixed in 17.8 g of DMF. The mixture was sonicated for 10 minutes at 750 W in pulses of two second on and one second off and amplitude of 85%. Then, 6.0 g of 10% silicon resin Silres REN-168 (polysiloxane) was added to the dispersion and bath sonicated for 5 minutes. The coating was prepared by spraying 3 ml of the above dispersion on heated (120° C.) Al substrate, with area of 5×5 cm². The samples were cured in an oven at 350° C. for two hours.

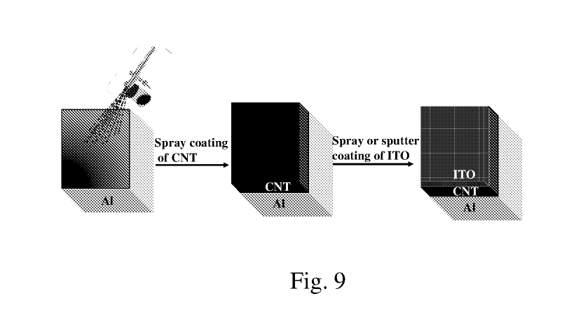

FIG. 9 illustrates the fabrication of CNT/ITO coating on Al substrate. The first layer composed of CNT and binder involves spraying of the liquid dispersions of CNT containing polysiloxane, which is converted into a heat-stable ceramic matrix upon heating. The second layer is composed of ITO, which is deposited on the CNT layer by spraying or sputtering.

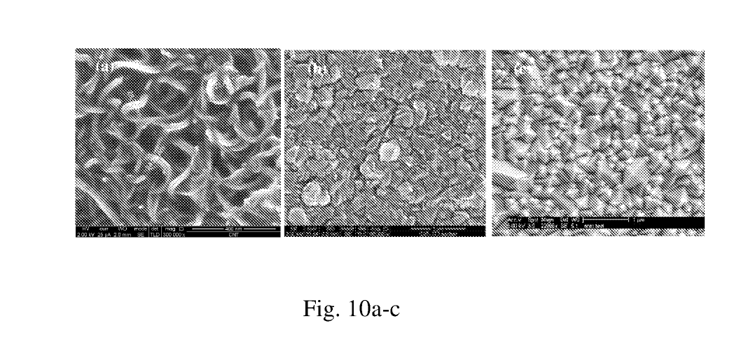

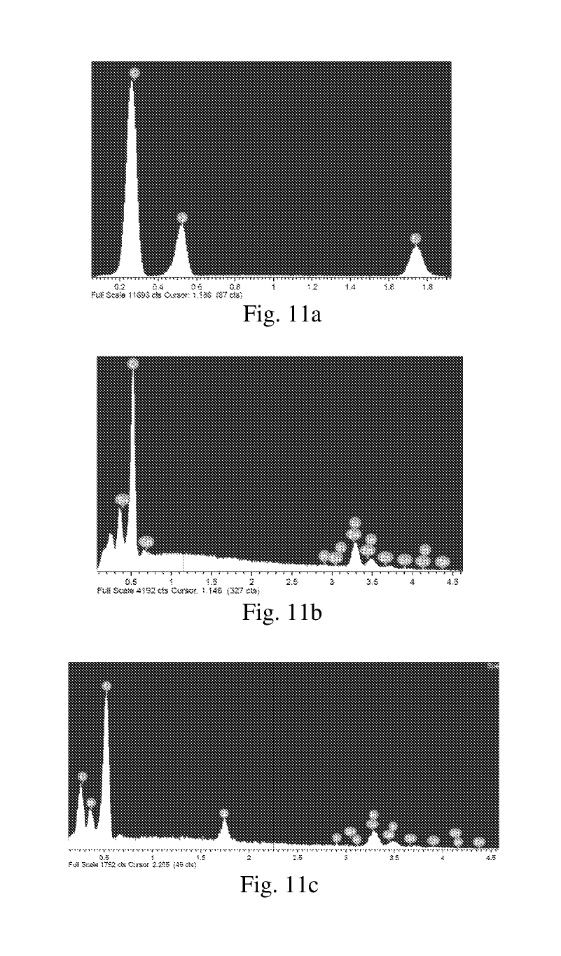

The coatings were characterized by SEM, EDX, and XRD. FIG. 10 shows the SEM image of a typical CNT coating. From the image (FIG. 10(a)) it is observed that the diameter of the CNT is in the range of 23-28 nm. The EDS measurement (FIG. 11) shows the signature of C from CNT and Si and O from the polysiloxane binder.

The thickness of the coatings was determined as 2-3 μm using micro-TRI-gloss μ.

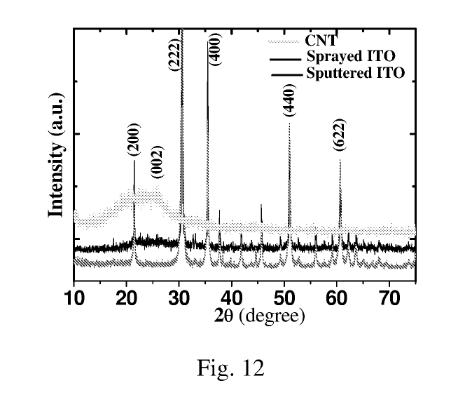

The XRD pattern of CNT coating also shows the signature of CNT at 2θ of 25° corresponds to the (002) plane (FIG. 12). FIG. 10 (b) presents SEM image of ITO coating of thickness of 1.2 μm on CNT coating prepared by sputtering. From the image, it is observed that ITO particles are crystalline and have triangular structure with an average size of 500 nm. The EDS analysis (FIG. 11) shows the signature of only Sn, In, and O. There is no signature of C from CNT coating which implies that the coating of ITO on CNT is uniform. The XRD pattern also shows the signature of ITO which is associated with the (200), (222), (400), (440), and (622) planes (FIG. 12).

FIG. 10(c) shows SEM image of CNT/ITO^{sprayed} coating. From the image, it is observed that particles are crystalline and have polyhedral structure with size in the range of 200 to 500 nm. The thickness of the film measured by micro-TRI-gloss μ was estimated as 1.1 to 1.5 μm. The EDS analysis (FIG. 11) shows the signature of Sn, In, and O from ITO and Si from polysiloxane. It should be noted that there is a signature of C in the EDS spectrum. The XRD pattern also shows the signature of ITO as in the case of sputtered ITO (FIG. 12).

### Absorptance and Emittance Measurement

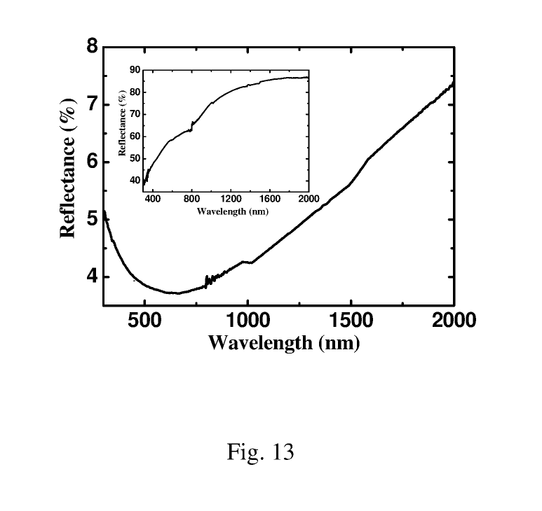

As noted above, the absorptance of the coatings were calculated from the UV-vis-NIR reflectance spectra using the equation; α+R+T=1, where α is absorptance, R is reflectance, and T is transmittance. Since the coatings were fabricated on Al substrate, the transmittance is zero and therefore the absorptrance α=1−R. FIG. 13 shows the reflectance spectra of Al substrate and CNT coating on Al substrate. From the inset of the figure, it is observed that Al substrate has very high reflectance in the solar spectrum region. The absorptance in the region of 0.3 μm to 2 μm was calculated as 0.267 (FIG. 13, inset). In case of CNT coating, it has one reflectance minima at 600 nm having a reflectance of 3.7% (FIG. 13). Thus, the coating has high absorptance of 0.963 at 600 nm. The absorptance in the main part of the solar spectrum region (450-700 nm)^{[37]} is 0.962 (FIG. 13) and the total absorptance of the coating in the full solar spectrum region of 0.3 μm to 2 μm was calculated as 0.945 (FIG. 13).

From the absorptance measurement, it is appreciated that CNTs absorb solar light strongly and reflect weakly, which make them superior candidate for solar light absorber. In spite of these advantages, the coating of CNT, suffers from low selectivity and radiative emission in the IR region. The CNT coating shows emittance of 0.8 (Table 7). Attempts have been made to inhibit the radiative emission of CNT coating in the IR region by coating with material, which is transparent to solar region but reflects light in the IR region, on top of the CNT coating. ‘Inverse tandem absorbing’ materials are transparent in the solar region but reflect light in the IR region, and significantly reduce the radiative emission in the IR region.

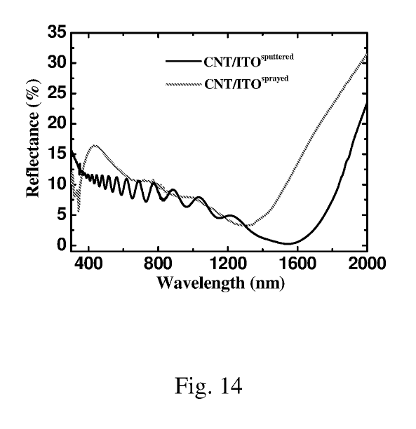

As noted above, ITO as a candidate for top layer coating because of its stability at high temperature, high carrier concentration, and low sensitivity to moisture. FIG. 14 shows the reflectance spectra of a CNT/ITO^{sputtered} coating having a 1.2 μm of ITO top layer and CNT/ITO^{sprayed} coating having a coating of sprayed ITO with an average thickness of 1.3 μm. It is seen that the CNT/ITO^{sputtered} coating has a reflectance minima at 1540 nm having reflectance of 0.3%. Thus, the coating has the absorptance of 0.997 at 1540 nm. The absorptance of CNT/ITO^{sputtered} coating in the NIR region (1300-1700 nm) is 0.988. This increase in absorptance of CNT/ITO^{sputtered} coating in the region of 1300-1700 nm may be due to the antireflecting property of ITO in that region. The total absorptance of the coating in the full solar spectrum region of 0.3 μm to 2 μm is 0.927. The emittance of the coating was ca. 0.2 (Table 1). Hence, adding a coating of ITO of 1.2 μm thickness on top of a CNT coating significantly decreases the emittance while only slightly affects the absorptance. The reflectance spectra (FIG. 14) of CNT/ITO^{sprayed} coating has a reflectance minima at 1300 nm having a reflectance of 3.1% and an absorptance of 0.969. The absorptance of CNT/ITO^{sprayed} coating in the NIR region (1100-1450 nm) is 0.956 and in the full solar spectrum region of 0.3 μm to 2 μm is 0.878 (FIG. 14). The emittance of the coating was ca. 0.3 (Table 7).

Without being bound by theory, this lower absorptance and higher emittance of CNT/ITO^{sprayed} coating as compared with CNT/ITO^{sputtered} coating may be due to the lower transmittance of ITO layer prepared by the spray method.

TABLE 7
Absorptance, emittance and adhesion properties of samples
with and without CNT coating and ITO coating.

| Sample | Absorptance | Emittance | Adhesion |
|---|---|---|---|
| Al | 0.267 | 0.06 | — |
| Al/CNT | 0.945 | 0.8 | 95% |
| Al/CNT/ITO^{sputtered} | 0.927 | 0.2 | >95% |
| Al/CNT/ITO^{sprayed} | 0.878 | 0.3 | 35-65% |

### Spectral Selectivity and Resistivity Tests

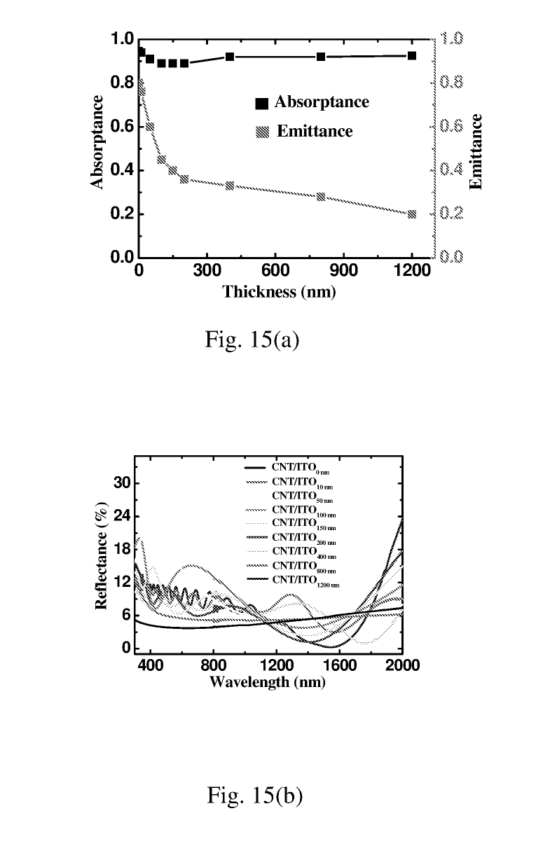

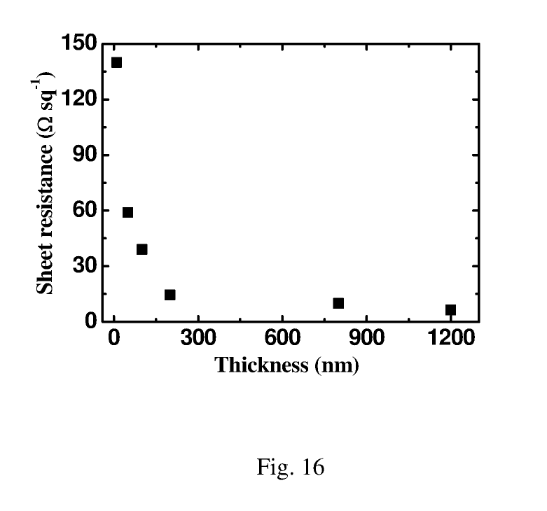

In order to attain a tuneable spectral selectivity, coatings of ITO with different thicknesses were fabricated by sputtering on top of the CNT coatings. FIG. 15(a) and FIG. 15(b) show the variation of absorptance and emittance of CNT/ITO^{sputtered} coating with the thickness of ITO coating. From FIG. 15(b), it is evident that the spectral selectivity of the absorbing coating is highly sensitive to the thickness of ITO layer. With the increase in the thickness of ITO, both the absorptance and emittance decreased up to the thickness of 0.2 μm. At 0.2 μm of thickness, the absorptance was 0.89 and emittance was 0.36. For coatings with thickness >0.2 μm the emittance decreased continuously with increasing the thickness of ITO but the absorptance started to increases. At 1.2 μm thickness, the emittance decreased to 0.2 whereas the absorptance increased to 0.927. With increase in the thickness of the ITO, there is a decrease in sheet resistance (displayed in FIG. 16) and hence there is an increase in the number of free electrons which is responsible for the IR reflectivity and thus decreases the emittance.

Without being bound by theory, the change in the absorptance of the coating with thickness of ITO is due to the change of the refractive index of ITO with the thickness.

### Adhesion Test

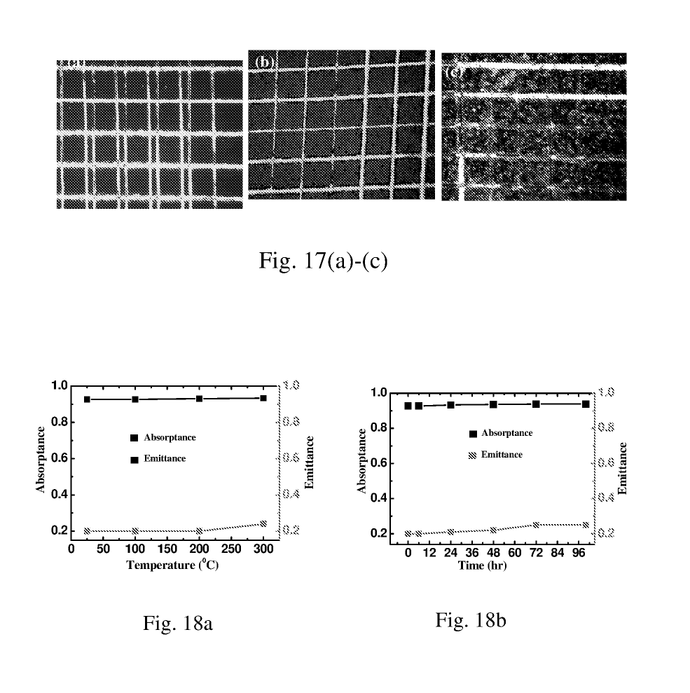

It can be seen from Table 7 and FIG. 17(a) that the adhesion of the CNT coating is very good (95%) and the scotch tape does not remove the coating. By this tape test, ˜5% of the coating was removed. High adhesion is achieved since the CNT in the resulting coating are embedded within a matrix, which by itself has good adhesion to metallic and other substrates. The coating had flaked along the edges and/or at the intersection of the cuts. The CNT/ITO^{sputtered} coating shows excellent adhesion of >95% (FIG. 17(b)) as less than 5% of the coating was removed by the tape test. On the hand, the CNT/ITO^{sprayed} coating shows moderate adhesion of 35-65% (FIG. 17(c)) as >50% of the coating was removed by the tape test.

### Stability of the Coat at High Temperature in Air

The thermosolar absorbers should operate at high temperatures, and therefore, heat stability was further evaluated. As displayed in absorptance, emittance and adhesion measurement in Table 7, CNT/ITO^{sputtered} shows better performance than that of CNT/ITO^{sprayed}. Thus, the performance evaluation of only CNT/ITO^{sputtered} coating was carried out by subjecting them to heat storage in air at various temperatures and time durations. The absorptance and emittance of the coatings were measured after cooling down to room temperature. FIG. 18(a) shows the absorptance and emittance measurements for samples stored at various temperatures for 6 hrs. From FIG. 18(a), it is observed that there is no noticeable change in the value of absorptance and emittance up to 200° C. At 300° C., slight increase in both absorptance and emittance occurred, leading towards lower spectral selectivity (0.934/0.24). The long term stability of the coating was evaluated at 250° C. and it shows very good spectral selectivity of 0.938/0.25 even after 100 hr (FIG. 18(b)). After 100 hr, there was a slow decrease in the spectral selectivity due to slow increase in emittance of the coating and after 7 day the spectral selectivity was 0.938/0.27. This decrease in spectral selectivity may be due to the oxygen adsorption on ITO layer as the heating was carried out in air. Due to the adsorption of oxygen, the free electrons which are responsible for IR reflectivity may be trapped. This was verified since the spectral selectivity was recovered by annealing the coating in N₂ at 450° C. for 1 hr. During annealing under N₂ at high temperature, the adsorbed O₂ was removed. As a result, trapped electrons become free and reflect IR light. After 7 day of heating at 250° C., the adhesion test was performed, resulting in very good adhesion of 95%.

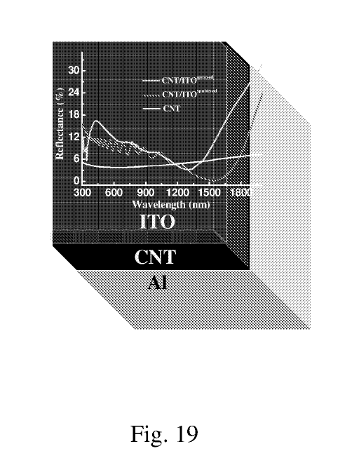

Fabrication of ‘inverse tandem’ absorbing coating CNT/ITO with excellent spectral selectivity has been demonstrated. As shown in FIG. 19 the CNT layer shows low reflectance in the solar spectrum, functions as an excellent solar absorber and the ITO layers which show higher reflectance in the IR region, function as emittance inhibitor and make the absorbing coating spectrally selective.

### Conclusions

In summary, the examples of the present disclosure display a new approach whereby the final spectrally selective solar thermal coating CNT/ITO is formed as a continuous and uniform layer which combines the absorber layer of CNT prepared by spraying and IR reflecting layer of ITO prepared by sputtering on top of the CNT coating. The coating exhibits excellent spectral selectivity with high absorptance of 0.927 and low emittance of 0.2. The deposition of ITO on CNT coating decreases the emissivity by at least 20% compared to that of without ITO coating.

Without being bound by theory, this decrease is due to the IR reflective property of ITO which reflects back the emitted heat towards the absorbing materials. The emissivity may be controlled by varying parameters such as the coating material or combination of several materials, the thickness of this layer, and matching properly the refractive index of the top coating.

The coating shows superior adhesion of >95% and high thermal stability up to 250° C. with very good selectivity even after 100 hr. The spectral selectivity can be tuned by varying the thickness of the ITO layer. The developed system shows promising results for future applications as solar thermal energy conversion.

### Absorbent Layer Coating for Reducing Stray Light

### Example 16

### Coating Formed from Dispersion of DMF Comprising MWCNT and SILRES REN 168 Binder—Evaluation of the MWCNT:Binder Ratio Effect

### Materials and Methods

Two multi-walled carbon nanotube (MWCNT) coating formulations were used: (1) Baytubes® C70 P (Bayer MaterialScience, Germany) characterized by a purity of N99%, a diameter of 13-16 nm and a length of 1-10 μm and (2) NC7000 (Nanocyl, Belgium) characterized by a purity of N90%, a diameter of 9.6 nm and a length of 0.5-2 μm. The starting coating formulations were composed of MWCNTs (0.5 wt. %), dispersing additive BYK 9077 (1 wt. %) (Byk-Chemie GmbH, Germany) and dimethylformamide (DMF) (98.5 wt. %) (Biolab, Israel).

The formulations were prepared using a horn sonicator (model Vibra-Cell, Sonics & Materials Inc., USA) for 20 min at 640 W. The samples were cooled in an ice water bath during the sonication process. This starting formulation was mixed at various ratios with a silicon-based binder. A binder solution was prepared by dissolving SILRES® REN 168 (0.5 wt. %) (Waker Chemie AG, Germany) in DMF. The final coating formulation was prepared by mixing the MWCNT dispersion and the binder solution at several ratios. The substrates and aluminum plates (1 mm ‘ 50 mm’ 50 mm size) were degreased by sonication in an acetone bath for 5 min. The coatings were formed by airbrush spraying 20 g of the coating solution onto heated aluminum plates (70° C.). The coated samples were further baked at 350° C. for 120 min.

The binder curing process was studied by TGA-MS analysis (40-350° C., in a heating rate of 10° C./min), using a STA TG-DSC 449 F3 Jupiter® instrument (NETZSCH, USA).

The diffuse reflectance of the coatings was measured in the VIS-NIR range (350-2400 nm) using a Cary 5000 spectrophotometer instrument (Varian, USA). Coating thickness was measured using a micro-TRI-gloss μ instrument (BYK Gardner GmbH, Germany).

### Results

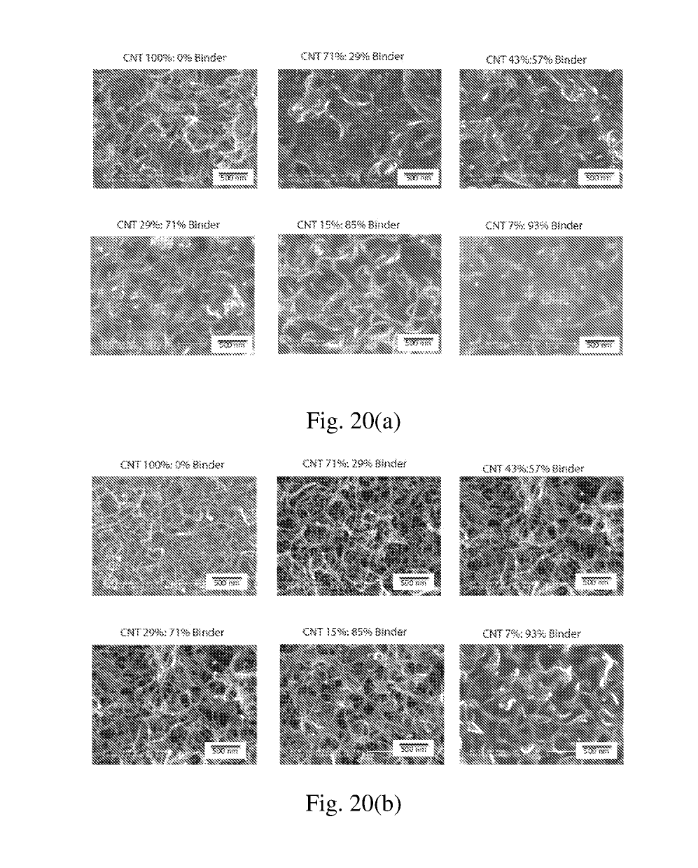

Black coatings were formed by spraying a constant amount of the coating formulation on an aluminum plate pre-heated at 70-100° C. The performance of the resulting coatings was evaluated by measuring the light reflectance (% R) in the range of 350-2400 nm To ensure a good adhesion of the black coating to the aluminum substrate, each formulation contains, in addition to the MWCNT as the absorbing material, a heat resistant binder, at various weight ratios. The evaluation of the effect of MWCNT:binder ratio was performed with coatings with a similar thickness, 2-3 μm. The measurements were also conducted for a formulation without a binder, and for a formulation with a binder only. After performing the spray coating, the resulting wet coatings were dried to evaporate the solvent, followed by baking at 350° C. for 2 h, to convert the binder into a ceramic matrix. The coating morphologies before and after baking are shown in FIGS. 20(a) and 20(b). As seen, prior to the thermal treatment there is a layer of the organic binder on top of the CNTs, while after baking this layer is partly removed, clearly showing the presence of entangled MWCNTs.

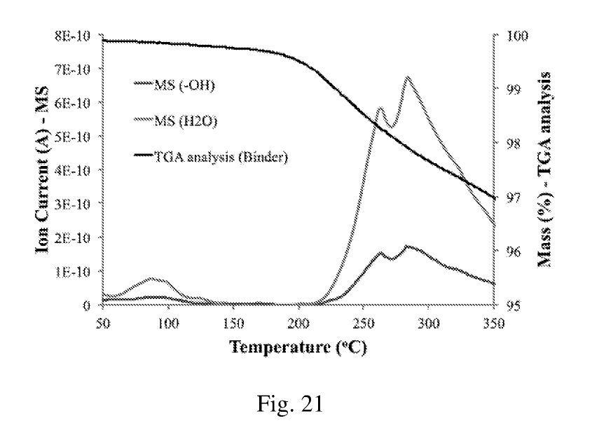

The thermal process for the binder curing process was studied by TGA-MS analysis. The binder material consists of siloxane chains with silanol end groups. During heating, the siloxane chains are cross linked by the condensation of —OH groups (releasing H₂O). It was found (FIG. 21) that the curing process starts at 200° C. At this temperature, as found by the MS, the decrease in the mass is due to the release of the —OH fragments and H₂O molecules.

### Optical Measurements

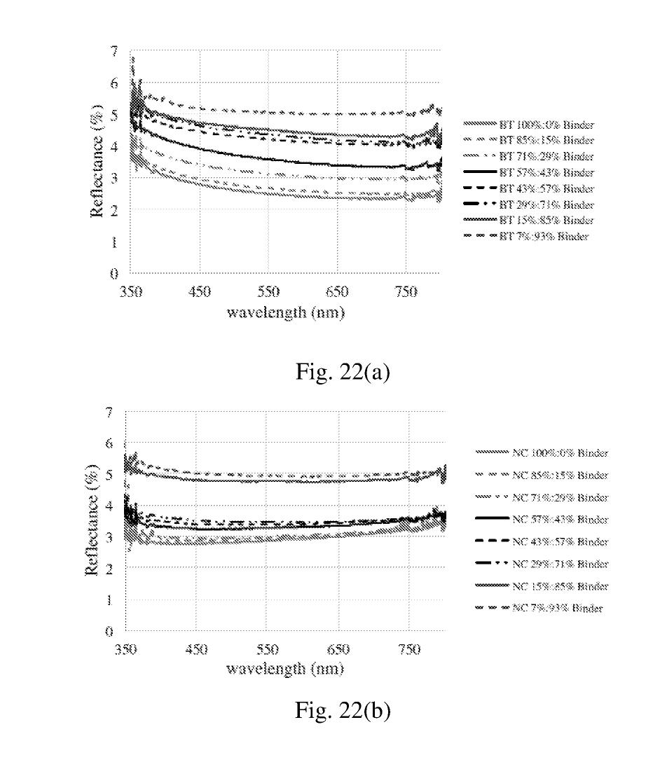

The reflectance of the coatings obtained by spraying was measured at the VIS-NIR range, and is presented as a function of wavelength (FIGS. 22(a) and 22(b)), and also as the calculated integral of reflectance (% R_{1,2}) at each range: % R₁ for 350-800 nm and % R₂ for 850-2400 nm (Table 8). The coating experiments were conducted with two types of CNTs, 1-10 μm long, Baytubes® C70 P (BT), and 0.5-1.5 μm long, Nanocyl 7000 (NC).

In the VIS range (350-800 nm) aluminum plates have the integral of reflectance % R₁=59.87(±3.35)%. After coating the substrate with the binder solution without CNTs, the reflectance slightly decreases up to % R₁=45.79(±10.98)%. The reflectance decreases significantly while using the coating formulations with the two types of MWCNTs: Coatings composed of 7% MWCNT/binder 93% has % R₁=5.11(±0.04)% (for BT type) and % R₁=5.05(±0.04)% (for NC type). A further decrease of % R₁ was found, as the concentration of the MWCNT in the coating increased, reaching a minimum value of % R₁=2.60(±0.01)% for BT and 2.82(±0.02)% for NC with coating composed of 100% MWCNT only (without binder).

In the NIR range (850-2400 nm), all the reflectance values were in the range of % R₂=4-6.5, however the dependence on MWCNT concentration was not very significant. It should be noted that at this range, the longer CNT tubes (BT) were slightly better than the shorter ones (NC), about 1% difference in reflectance value.

TABLE 8
Integral of reflectance in VIS (% R1) and NIR (% R2) ranges of BT and NC
coatings with various MWCNT:binder ratios.

| | BT | | NC | |
|---|---|---|---|---|
| Coating composition | % R₁ | % R₂ | % R₁ | % R₂ |
| MWCNT:binder | 350-800 nm | 850-2400 nm | 350-800 nm | 850-2400 nm |
| 100%:0% | 2.60% (±0.01) | 4.05% (±0.06) | 2.82% (±0.02) | 5.41% (=0.32) |
| 85%:15% | 2.75% (±0.01) | 3.93% (±0.06) | 2.95% (±0.04) | 5.45% (±0.07) |
| 71%:29% | 3.18% (±0.06) | 4.22% (±0.11) | 3.04% (±0.08) | 5.45% (±0.09) |
| 57%:43% | 3.67% (±0.00) | 4.50% (±0.12) | 3.33% (±0.06) | 5.55% (±0.03) |
| 43%:57% | 4.29% (±0.01) | 5.20% (±0.10) | 3.51% (±0.04) | 5.50% (±0.13) |
| 29%:71% | 4.44% (±0.03) | 4.61% (±0.11) | 3.54% (±0.00) | 5.13% (±0.02) |
| 15%:85% | 4.56% (±0.05) | 4.93% (±0.11) | 4.86% (±0.04) | 5.59% (±0.14) |
| 7%:93% | 5.11% (±0.04) | 5.94% (±0.23) | 5.05% (±0.04) | 6.53% (±0.42) |
| 0%:100% | 45.79% (±1.98) | 75.89% (±1.80) | 45.79% (±1.98) | 75.89% (±1.80) |
| A1 only | 59.87% (±3.35) | 80.33% (±4.58) | 59.87% (±3.35) | 80.33% (±4.58) |

### Adhesion Tests

The adhesion of the coatings to the aluminum substrates was evaluated by two standard tape test with cross-cut, in which the adhesion is rated according to the fraction of detached coating, and classified according to a standard scale. The adhesion results are presented in Table 9 according to ISO 2409 (0 grade is the best, without detached coating, grade 5 is the worst, above 65% detachment), and according to ASTM D3359 (5B grade is the best, without detached coating, OB is the worst, above 65% detachment).

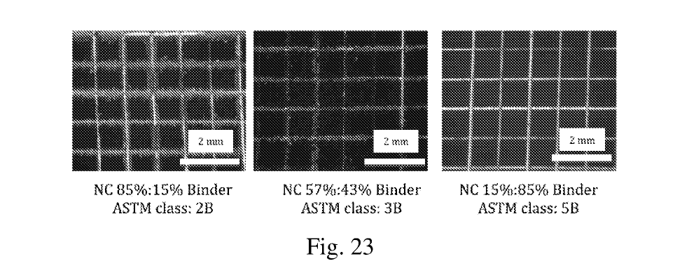

Coatings with a high content of MWCNT (>85%) but with low binder concentration (<15%) presented a poor adhesion (class 3; class 2B) (typical adhesion results are presented in FIG. 23). The adhesion is improved while increasing the binder concentration: good adhesion was achieved in samples containing 29-71% MWCNTs and 71-29% binder (class 2; class 3B). Excellent adhesion was observed in samples where the binder concentration was >85% (class 0; class 5B).

Two types of nanotubes (short and long) were used to form two series of MWCNT:binder coatings.

It was expected that the longer nanotubes would form a more entangled and dense net structure compared to the short tubes. This difference in morphology could provide a higher cohesion force and interaction between the tubes, resulting in a higher adhesion to the substrate. However, on the contrary, it is interesting to note that the adhesion is affected only by the binder concentration while it is not affected by the length of the MWCNT.

TABLE 9
Adhesion classification of different CNT coatings according
to ASTM and ISO standard methods.

| | Coatings | | After thermal | |
|---|---|---|---|---|
| | as prepared | | cycling test | |
| | ASTM | | ASTM | |
| MWCNT:binder | D3359 | ISO 2409 | D3359 | ISO 2409 |
| 100%:0% | Class 2B | Class 3 | Class 0B | Class 5 |
| 85%:15% | Class 2B | Class 3 | Class 0B | Class 5 |
| 71%:29% | Class 3B | Class 2 | Class 3B | Class 2 |
| 57%:43% | Class 3B | Class 2 | Class 3B | Class 2 |
| 43%:57% | Class 3B | Class 2 | Class 3B | Class 2 |
| 29%:71% | Class 3B | Class 2 | Class 3B | Class 2 |
| 15%:85% | Class 5B | Class 0 | Class 5B | Class 0 |
| 7%:93% | Class 5B | Class 0 | Class 5B | Class 0 |

### Temperature Stability Tests

Black coatings for stray light reduction may be used not only in conventional optical devices (operating in the terrestrial conditions) but also in space applications (for e.g. satellites). For both applications, coatings may be exposed to high temperatures due to the proximity with high heat dissipating parts, where the temperature is likely to go around 200° C. for long periods. In space applications, black coatings in satellites are exposed to low temperatures when present in the shadowed area.

Thermal cycling test is performed in order to simulate space environment. The European Space Agency standard (ESA ECSS-Q-70-04A, 2008) recommends to perform 100 cycles of cooling (−100° C.) and heating (100° C.) of samples under low pressure (10⁻⁵ Pa) with a dwell time of at least 5 min In this work we used a different protocol with higher and lower temperatures: The thermal test was performed for high temperature stability (by heating the coatings at 200° C. for 2 h) and for low temperature stability (by dipping the coatings in liquid N₂ for 2 h). In this research we aimed at showing that the high absorbing black coatings are stable at very high and very low temperatures.

Thermal cycling test was performed by dipping the samples in liquid N₂ (−196° C.) for 5 min, bringing them to room temperature for 5 min and introducing them into an oven at 200° C. for 5 min. This cycle was repeated 10 times.

After thermal tests, the coatings were examined visually for morphological damage (by an optical microscope), for optical properties (% R) and for adhesion (by cross-cut and tape test).

It was found that the samples showed a good stability at high temperature, coating flaking was not observed, and the optical and adhesion properties remained similar before and after the test. The thermal test at low temperature showed different results. Although optical properties were retained after the tests and there was no visual indication for damage, it was found that there was a deterioration in the adhesion of the samples rich in CNT compared to the binder. The failure was observed for samples having 85% MWCNT and above. Adhesion of such samples decreased from ASTM class 2B/ISO class 3 to ASTM class OB/ISO class 5. The same results were observed after the thermal cycling test (Table 9), probably due to the lack of the binder at these concentrations of CNTs.

### Coating Complex Structures

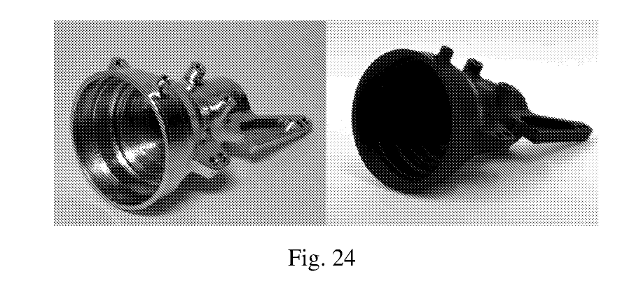

The method proposed in the present disclosure provides a simple and low cost approach for producing non-reflective, high light-absorbing coatings by wet deposition of CNTs. This method provides a coat on 3D structures in a very short time, where the black coating is required in complexes and relatively large areas. FIG. 24 shows an internal piece of an optical device before and after coating with the CNT-based formulation according to the present invention.

### Conclusions

Highly absorbing black coatings composed of MWCNT can be formed by a very simple and low cost formulation. CNTs are dispersed in surfactant solution of DMF and then mixed with a silicon based binder solution. The coatings are obtained by various simple wet deposition methods, such as spray coating, dipping, painting, coil coating and bar coating, which allows coating flat and complex 3D structures.

The adhesion properties are controlled by the MWCNT/binder concentration. Increasing the binder concentration the adhesion is improved. The optimal ratio MWCNT/binder for a satisfactory adhesion should be evaluated in view of the final application requirements.

The binder/CNT ratio affects significantly the optical properties of coatings. The reflectance in the VIS range decreases when decreasing the binder/CNT ratio. It should be noted that the research was focused mainly on black coating for visible light absorption, which consists the main optical noise (stray light) in optical instruments. It was found that such coatings also provide a low reflectance in the NIR range.

All the coatings showed an excellent stability at high temperature, while maintaining their optical and adhesion properties. At very low temperature, the samples maintained their optical properties, but the adhesion was deteriorated in coatings containing low binder concentration.

1.-74. (canceled)

75. A light-absorbing element coated on at least a region of its surface with a film of at least one light-absorbing material, the light-absorbing material being associated with at least one binder material, the film being between 1 and 20 μm thick and having light absorption of at least 90%.

76. The element according to claim 75, for stray-light suppression.

77. The element according to claim 75, wherein the film having light absorbance of 90%, 91%, 92%, 93%, 94%, 95%, 96%, 97%, 98% or 99%.

78. The element according to claim 75, wherein the at least one light-absorbing material constitutes between 1% and 10% (w/w) of the film material.

79. The element according to claim 75, wherein the at least one light-absorbing material absorbs light in the ultraviolet and visible spectrum.

80. The element according to claim 79, wherein in the visible range (380-750 nm), light absorbance is at least 96%, or wherein in the NIR range (700-1000 nm), light absorption is at least 96%, or wherein at a wavelength of between 1000-1700 nm, light absorbance is at least 94%, or wherein light absorbance is at least 93% at a wavelength range of 1700-2500 nm.

81. The element according to claim 79, wherein the light absorbing material is a carbon allotrope or a material selected from carbon nanotubes (CNTs), graphene and fullerenes.

82. The element according to claim 75, wherein the binder material is selected amongst inorganic materials configured to receive a dispersion of at least one light-absorbing material.

83. The element according to claim 82, wherein the binder material is a ceramic material.

84. The element according to claim 75, comprising a ceramic film and the at least one light-absorbing material embedded in the film, the film being between 1 and 20 μm thick.

85. The element according to claim 75, wherein the film comprises a ceramic material embedding CNT, the material ratio between the ceramic material and the CNT being between 1:1 and 3:1.

86. The element according to claim 75, comprising a substrate coated with a film of a ceramic material and CNT, the film being between 2 and 5 μm thick, wherein the CNT constitutes at least 1% (w/w) of the film material and wherein the film having an absorbance of at least 90%.

87. The element according to claim 75, comprising:
a first layer of a composite comprising at least one binder material and at least one light-absorbing material; and
a second layer comprising an infrared (IR) reflecting material.

88. The element according to claim 75, comprising a first layer of a composite comprising a ceramic material and CNT; and a second layer comprising an infrared (IR) reflecting material, the element having emissivity below 0.8 at the NIR range.

89. A light-absorbing element coated on at least a region of its surface with a film of at least one light-absorbing material, the light-absorbing material being associated with at least one binder material, the film being between 1 and 20 μm thick and a film of an IR reflecting material, the element having light absorption of at least 90%.

90. The element according to claim 88, wherein the film of an IR reflecting material comprises a material selected from the group consisting of SnO₂, In₂O₃, In doped SnO₂ (ITO), Sb doped SnO₂ (ATO), Cd₂SnO₄, SiC, GaN, AlN, BN, HfC and LaB₆.

91. The element according to claim 75, wherein the element substrate is of a material selected from a metal, glass, an inorganic material, a polymeric material and a ceramic material.

92. A device comprising an element according to claim 75.

93. The device according to claim 91, being selected from an optical electronic and optoelectronic device.

94. A thermosolar device comprising an element according to claim 75.

95. A method of fabricating a light-absorbing film on a surface region of a substrate, comprising:
forming on a surface region at least one absorbing layer comprising
a light-absorbing material; and
a polymerizable binder resin;
heating said at least one absorbing layer to induce polymerization of said binder resin; and
optionally forming at least one IR radiation reflecting layer on said polymerized binder.
